(19) United States
(12) Patent Application Publication
(10) Pub. No.: US 2009/0010355 A1
(43) Pub. Date: Jan. 8, 2009

(54) RADIO COMMUNICATION APPARATUS AND RADIO COMMUNICATION METHOD

(75) Inventors: Hiroki MORI, Kawasaki-shi (JP); Yasuhiko TANABE, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/137,106

(22) Filed: Jun. 11, 2008

(30) Foreign Application Priority Data
Jun. 25, 2007 (JP) 2007-166760

(51) Int. Cl. H04B 7/02

(52) U.S. Cl. 375/267

(57) ABSTRACT

There is provided with a radio communication apparatus for communicating with a receiver. A transmission rate control unit in the radio communication apparatus specifies a signal having small variation of a metric, which is an index for evaluating a channel of the signal, out of first to nth signals to be transmitted to the receiver. The transmission rate control unit controls a transmission rate of a specified signal based on a channel responses and a transmission weight of the specified signal and controls a transmission rate of each of other signals different from the specified signal out of the first to nth signals based on a relationship between a variation characteristic of a metric of the specified signal and a variation characteristic of a metric of each of the other signals.

### CROSS REFERENCE TO RELATED APPLICATIONS

This application is based upon and claims the benefit of priority from the prior Japanese Patent Applications No. 2007-166760, filed on Jun. 25, 2007; the entire contents of which are incorporated herein by reference.

### BACKGROUND OF THE INVENTION

1. Field of the Invention

The present invention relates to a radio communication apparatus and a radio communication method carrying out communication using a plurality of antennas, and more particularly, to a radio communication apparatus and a radio communication method exercising transmission rate control.

2. Related Art

As a transmission scheme capable of enhancing the speed of existing radio communication, a transmission scheme called “MIMO (Multiple Input Multiple Output)” is proposed which carries out communication using a plurality of transmission antennas and a plurality of reception antennas (e.g., I.E. Telatar, “Capacity of Multi-Antenna Gaussian Channels,” European Trans. On Telecommunications, vol. 10, no. 6, pp. 585-595, November 1999). The MIMO transmission scheme is a technique whereby independent streams are transmitted multiplexed at an identical frequency from a plurality of transmission antennas and a reception terminal separates the mixed streams through spatial filtering and maximum likelihood estimation. FIG. 1 is a conceptual diagram of communication using the MIMO transmission scheme. The figure shows a transmission terminal provided with a transmission processing unit 1001 which carries out MIMO transmission using antennas 1002 (1002a, 1002b, 1002c) and a reception terminal provided with a reception processing unit 2001 which receives signals transmitted from the transmission terminal using antennas 2002 (2002a, 2002b, 2002c). Under the normal MIMO transmission scheme, the transmission terminal requires no channel response from/to the reception terminal. For this reason, channel response is unknown to the transmission terminal under the normal MIMO transmission scheme, and therefore it is not possible to assign an appropriate transmission rate to each transmission stream.

On the other hand, under the MIMO transmission scheme, if a channel response to/from the reception terminal is known to the transmission terminal, a further increase of transmission capacity can be expected. One of techniques for realizing this is a technique called “transmission beam forming scheme.” FIG. 2 shows a conceptual diagram in a case where a transmission beam forming scheme is applied to a MIMO transmission scheme. The figure shows a transmission terminal provided with a transmission processing unit 3001 which carries out MIMO beam transmission using antennas 3001 (3002a, 3002b, 3002c) and a reception terminal provided with a reception processing unit 4001 which receives signals beam-transmitted from the transmission terminal using antennas 4002 (4002a, 4002b, 4002c). When a transmission beam forming scheme is applied as the MIMO transmission scheme, it is possible to carry out transmission by forming directional beams based on the channel response and transmit the respective streams without crosstalk. Furthermore, when the transmission beam forming scheme is applied as the MIMO transmission scheme, channel responses are known to the transmission terminal and therefore an appropriate transmission rate can be assigned to each transmission stream individually (e.g., JP-A 2001-237751 (Kokai)).

Normally, in order for a transmission terminal to acquire a channel responses under a transmission beam forming scheme, packet switching is required whereby the transmission terminal transmits a known signal for estimating channel responses to a reception terminal and the reception terminal reports the estimated channel response result to the transmission terminal.

When the transmission beam forming scheme is applied to a data packet, if packet switching for acquiring channel responses is always performed before transmitting data frames, the data packet can be transmitted with optimum directional beams and at an optimum transmission rate. However, if packet switching for the transmission apparatus to acquire channel responses is carried out every time a data packet is transmitted, overhead increases and the throughput of the entire system decreases.

Therefore, when the transmission beam forming scheme is applied under the MIMO transmission scheme, the transmission apparatus performs packet switching once to acquire a channel response and performs transmission beam forming transmission using the same channel response across a plurality of data packets, and overhead may be thereby reduced.

When the channel response acquired once by the transmission terminal is used across a plurality of data packets, if an elapsed time after acquiring the channel response increases, a channel response known to the transmission terminal may not coincide with the actual channel response. Since radio channels generally vary with time, if the lapse of time after the transmission terminal acquires (calculates) a channel response (may also be defined as a lapse of time after the reception terminal estimates the channel response and hereinafter, this may also be collectively referred to as a “delay time”), the time variation of the channel cannot be ignored and the channel response known to the transmission terminal may differ from the actual channel response. As a result, the directional beam and transmission rate applied to the data packet are no longer optimum. Especially when the transmission rate assigned to each stream based on a channel response known to the transmission terminal is of a higher order than the optimum transmission rate for the actual channel response, packet errors and accompanying packet retransmissions frequently occur and the throughput of the entire system deteriorates.

### SUMMARY OF THE INVENTION

According to an aspect of the present invention, there is provided with a radio communication apparatus for communicating with a receiver by using a plurality of antennas, comprising:

a channel response acquisition unit configured to acquire channel responses between the receiver and the antennas;

a transmission weight generation unit configured to generate first to nth (n is an integer equal to or greater than 2) transmission weights by which first to nth signals to be transmitted to the receiver are multiplied based on the channel responses;

a transmission rate control unit
configured to specify a signal having small variation of a metric, which is an index for evaluating a channel of the signal, out of the first to nth signals and control a transmission rate of a specified signal based on the channel responses and the transmission weight of the specified signal and
configured to control a transmission rate of each of other signals different from the specified signal out of the first to nth signals based on a relationship between a variation characteristic of a metric of the specified signal and a variation characteristic of a metric of each of the other signals;

a transmission weight multiplication unit configured to multiply the first to nth signals subjected to transmission rate control by the first to nth transmission weights to generate first to nth weight-multiplied signals; and

a transmission unit configured to transmit the first to nth weight-multiplied signals using the antennas respectively.

According to an aspect of the present invention, there is provided with a radio communication method of communicating between a transmitter having antennas and a receiver having antennas, comprising:

acquiring channel responses between the receiver and the transmitter;

generating first to nth (n is an integer equal to or greater than 2) transmission weights by which first to nth signals to be transmitted from the transmitter to the receiver are multiplied based on the channel responses;

specifying a signal having small variation of a metric, which is an index for evaluating a channel of the signal, out of the first to nth signals;

controlling a transmission rate of a specified signal based on the channel responses and the transmission weight of the specified signal;

controlling a transmission rate of each of other signals different from the specified signal out of the first to nth signals based on a relationship between a variation characteristic of a metric of the specified signal and a variation characteristic of a metric of each of the other signals;

multiplying the first to nth signals subjected to transmission rate control by the first to nth transmission weights to generate first to nth weight-multiplied signals; and

transmitting the first to nth weight-multiplied signals using the antennas respectively.

### BRIEF DESCRIPTION OF THE DRAWINGS

FIG. 1 is a conceptual diagram of a MIMO transmission scheme;

FIG. 2 is a conceptual diagram of a MIMO transmission scheme to which a transmission beam forming scheme is applied;

FIG. 3 is a block diagram of a radio communication apparatus according to an embodiment of the present invention;

FIG. 4 is a block diagram showing an example of the coding unit in FIG. 3;

FIG. 5 is a block diagram showing another example of the coding unit in FIG. 3;

FIG. 6 illustrates calculations carried out by the weight multiplication unit in FIG. 3;

FIG. 7 is a block diagram for performing channel response estimation at a reception terminal;

FIG. 8 is a block diagram different from that in FIG. 7 for performing channel response estimation at the reception terminal;

FIG. 9 illustrates a channel capacity variation characteristic with respect to a delay time (small correlation);

FIG. 10 shows an example of a Look-Up Table showing a relationship between channel capacities and transmission rates;

FIG. 11 shows another example of the reference table showing a relationship between channel capacities and transmission rates;

FIG. 12 shows a further example of the Look-Up Table showing a relationship channel capacities and transmission rates;

FIG. 13 shows a still further example of the Look-Up Table showing a relationship between channel capacities and transmission rates;

FIG. 14 illustrates a channel capacity variation characteristic with respect to a delay time (medium correlation);

FIG. 15 illustrates a channel capacity variation characteristic with respect to a delay time (large correlation);

FIG. 16 shows an example of a Look-Up Table showing disparities in channel capacity between signals when a delay time is sufficiently large;

FIG. 17 shows an example of the Look-Up Table showing a channel capacity convergence value of each signal when a delay time is sufficiently large;

FIG. 18 shows another example of the Look-Up Table showing a channel capacity convergence value of each signal when a delay time is sufficiently large;

FIG. 19 shows an example of a Look-Up Table showing a channel capacity variation characteristic with respect to a delay time; and

FIG. 20 shows another example of the Look-Up Table showing a channel capacity variation characteristic with respect to a delay time.

### DETAILED DESCRIPTION OF THE INVENTION

### First Embodiment

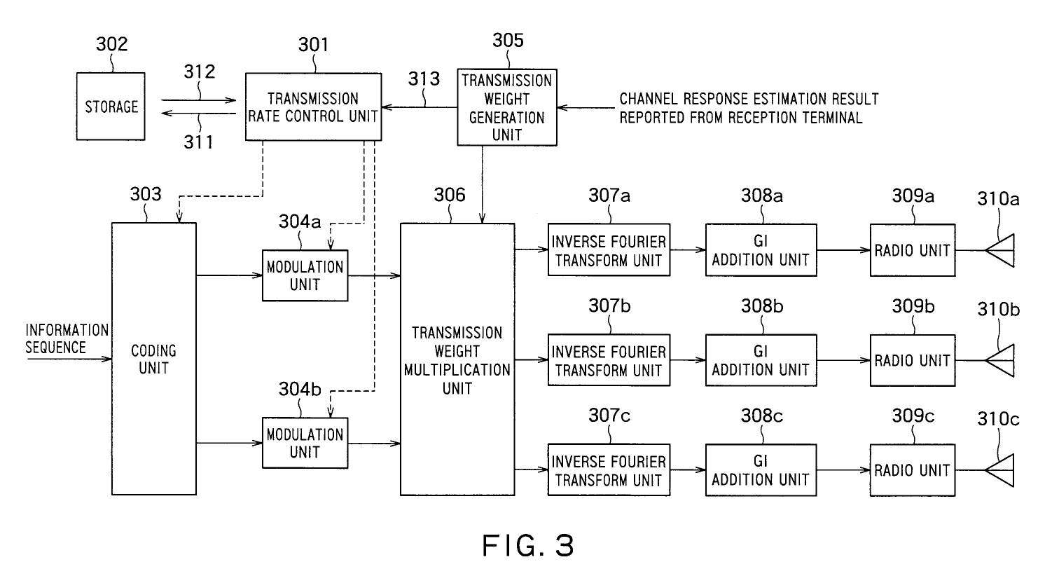

A transmission apparatus of a radio communication apparatus according to a first embodiment of the present invention will be explained with reference to FIG. 3. FIG. 3 is an example of a block diagram of the radio communication apparatus according to an embodiment of the present invention, which will be explained taking a case where the number of transmission streams multiplexed is two and the number of transmission antennas is three as an example.

The transmission apparatus of the radio communication apparatus of this embodiment is constructed of a transmission rate control unit 301, a storage 302, a coding unit 303, modulation units 304 (304a, 304b), a transmission weight generation unit 305, a transmission weight multiplication unit 306, inverse Fourier transform units 307 (307a, 307b, 307c), guard interval (GI: Guard Interval) addition units 308 (308a, 308b, 308c), radio units 309 (309a, 309b, 309c) and transmission antennas 310 (310a, 310b, 310c).

### (Transmission Rate Control Unit)

The transmission rate control unit 301 calculates a metric value for determining a transmission rate for each transmission stream based on an inputted signal and inputs the metric value as a metric signal 311 to the storage 302. Furthermore, the transmission rate control unit 301 reports a transmission rate selection signal 312 showing a transmission rate of each transmission stream reported from the storage 302 according to the input of the metric signal 311 to the coding unit 303 and the modulation units 304.

### (Storage)

The storage 302 stores a Look-Up Table for determining a transmission rate, refers to the table based on the metric signal 311 inputted from the transmission rate control unit 301, selects a transmission rate for each transmission stream and reports the transmission rate as the transmission rate selection signal 312 to the transmission rate control unit 301.

### (Coding Unit)

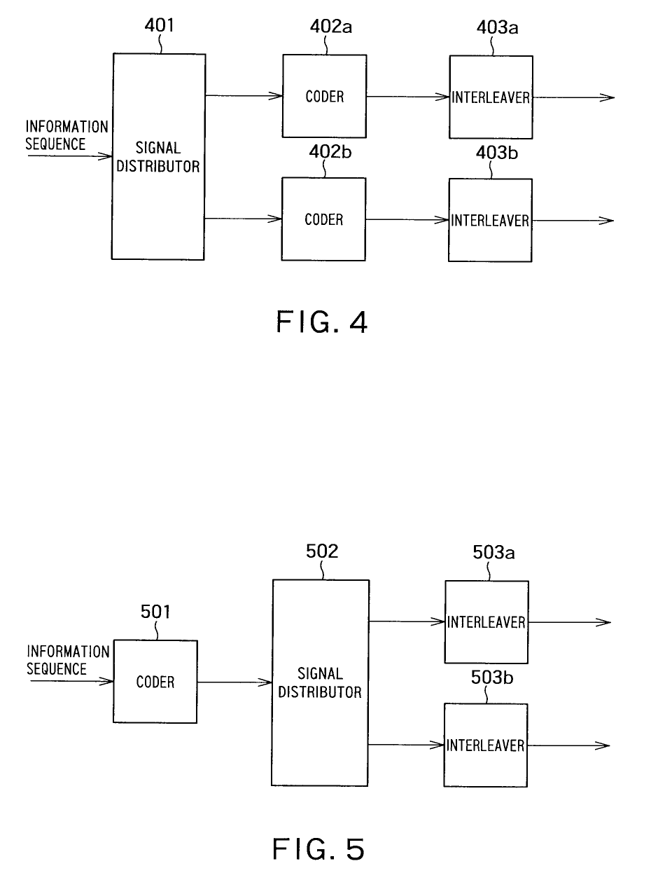

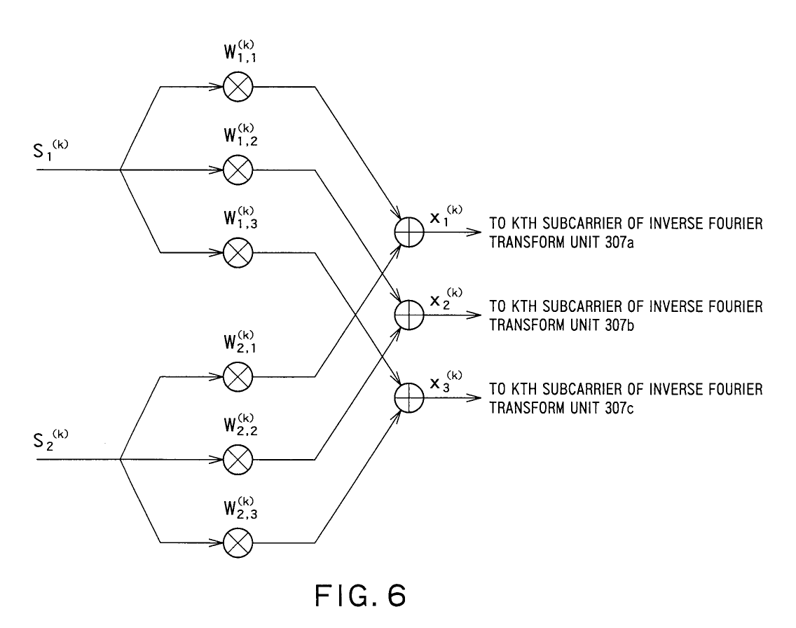

The coding unit 303 codes an information sequence from a higher layer based on the coding rate reported from the transmission rate control unit 301 and obtains a coded signal. Any coding scheme may be used as the coding scheme for generating a coded signal such as Reed-Solomon code, convolutional code and turbo code, LDPC (Low Density Parity Check) code. Moreover, the coding scheme of the present invention is not limited to these schemes and any scheme may be used as far as it is a coding scheme that can be decoded by a reception terminal. A configuration example of the coding unit for obtaining a coded signal will be explained later with reference to FIG. 4 and FIG. 5.

### (Modulation Unit)

The coded signal outputted from the coding unit 303 is modulated into a modulated signal for each subcarrier at the modulation units 304 based on the modulation scheme determined by the transmission rate control unit 301. The modulation scheme used by the modulation units 304 may be, for example, PSK (Phase Shift Keying) scheme such as BPSK and QPSK or may be a QAM (Quadrature Amplitude Modulation) scheme such as 16QAM, 32QAM, 64QAM and 256QAM. The modulation scheme according to the present invention is not limited to the above described two modulation schemes and any other modulation schemes may also be used. Any modulation scheme may be used as far as it is a modulation scheme that can be demodulated by a reception terminal which is the other party of transmission of a transmission terminal having a transmission apparatus.

### (Transmission Weight Generation Unit)

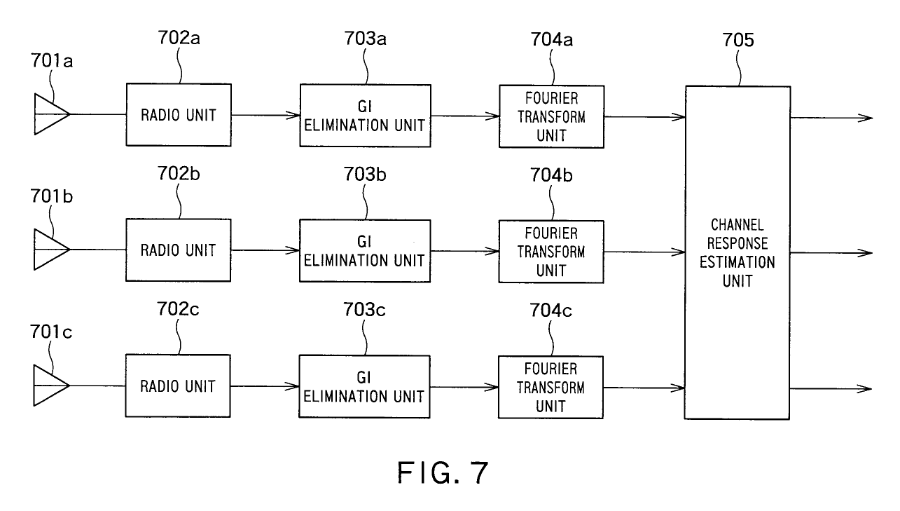

The transmission weight generation unit 305 acquires a channel response between the transmission terminal and reception terminal, that is, between the antennas 310 of the transmission terminal and the antennas 701 at the reception terminal (see FIG. 7) and generates as many transmission weights as radio sets (sets of a radio unit and a antenna) for each subcarrier based on the acquired channel response for each transmission stream. The transmission weight generation unit 305 is provided with a channel response acquisition unit which acquires a channel response between the antennas 310 of the transmission terminal and the antennas 701 at the reception terminal.

### (Transmission Weight Multiplication Unit)

The transmission weight multiplication unit 306 receives each modulated signal modulated by the modulation unit 304 for each subcarrier as input and multiplies each modulated signal by the corresponding transmission weight generated by the transmission weight generation unit 305. Details of multiplication carried out by the transmission weight multiplication unit 306 will be explained later with reference to FIG. 6, for example.

### (Inverse Fourier Transform Unit)

The inverse Fourier transform units 307 apply an inverse discrete Fourier transform to the respective output signals (weight-multiplied signals) from the transmission weight multiplication unit 306. Here, the inverse Fourier transform units 307 may use an IFFT (Inverse Fast Fourier Transform) or an IDFT (Inverse Discrete Fourier Transform) as far as the inverse Fourier transform units 307 can at least execute an inverse discrete Fourier transform. Signals subjected to inverse discrete Fourier transform are converted from parallel to serial and outputted as time series signals from the inverse Fourier transform units 307.

### (GI Addition Unit)

The GI addition units 308 add a guard interval (GI) to the respective time series signals. The guard interval is a technique generally used in an OFDM transmission scheme and since the guard interval has no effect on the essence of the present invention, detailed explanations thereof will be omitted.

### (Radio Unit and Antenna)

The radio units 309 convert an inputted signal to an analog signal by a digital/analog (D/A) converter, convert the analog signal to an RF signal by a frequency converter and output the RF signal to the respective transmission antennas 310 through a power amplifier (PA). Here, since the radio units 309 according to this embodiment are general radio units and have no special function, detailed explanations thereof will be omitted. Furthermore, any antenna may be used as the transmission antenna 310 as far as it is an antenna that can transmit a signal at a desired frequency.

### (Features of Radio Communication Apparatus)

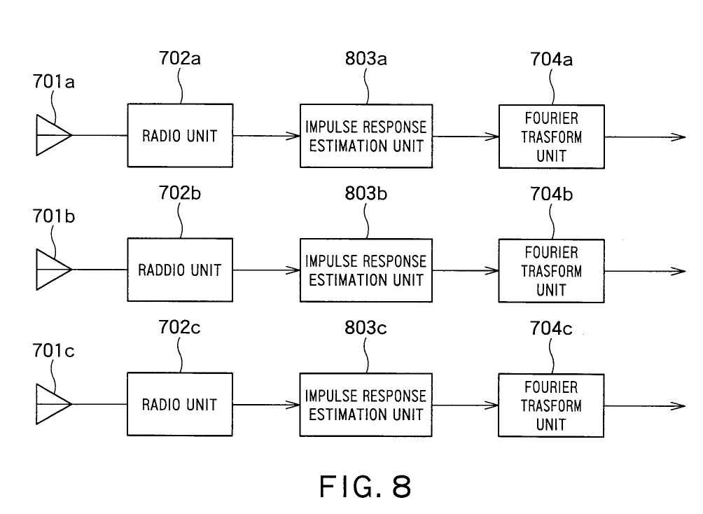

As explained above, the transmission apparatus of the radio communication apparatus of this embodiment performs transmission using a weight which differs from one modulated signal to another of each subcarrier. As a result, the respective modulated signals are transmitted through beams with different directionalities. Therefore, the radio communication apparatus can make its transmission characteristic vary a great deal according to the weight used for transmission. If an optimum weight is determined based on a channel response between the transmission and reception terminals, the radio communication apparatus of this embodiment can perform transmission using the optimum weight. Furthermore, the transmission apparatus of the radio communication apparatus according to this embodiment performs transmission by adaptively determining the coding rate and modulation scheme when generating modulated signals of the respective subcarriers. Therefore, the radio communication apparatus can make the transmission characteristic vary a great deal according to the coding rate and modulation scheme used for transmission. The optimum coding rate and modulation scheme are determined by the channel response to/from the reception terminal and the features of the present invention which will be described later and this allows the radio communication apparatus of this embodiment to carry out communication using an optimum transmission rate. Estimation of a channel response will be explained later with reference to FIG. 7 and FIG. 8.

### (Detailed Explanation of Coding Unit)

Next, a configuration example of the coding unit 303 for obtaining a coded signal will be explained with reference to FIG. 4 and FIG. 5. The coding unit 303 is constructed of a signal distributor, coders and interleavers shown in FIG. 4 or FIG. 5. Any coding scheme such as a Reed-Solomon code, convolutional code, turbo code or LDPC code may be used for the coding scheme used in the coder. Furthermore, the coded signal is a signal resulting from coding an inputted information sequence, and may be divided into two portions by a signal distributor 401 as shown in FIG. 4 and then coded by two coders 402a and 402b or may be coded by one coder 501 and then divided into two portions by a signal distributor 502 as shown in FIG. 5. What is required is that two coded signals be outputted from the coding unit 303. Furthermore, the interleavers 403a, 403b, 503a and 503b may interleave the coded signal and the reception terminal may rearrange the signal into a known sequence to prevent burst errors. The two interleavers may change the sequence under the same rule or under different rules. As far as the rearranged signal sequence is known to the reception terminal, the interleavers may rearrange the signal using any sequence.

### (Detailed Explanation of Transmission Weight Multiplication Unit)

Next, the signal outputted by the transmission weight multiplication unit 306 in FIG. 3 will be explained with reference to FIG. 6. FIG. 6 shows a case where attention is focused on only a kth (k is a natural number) subcarrier calculated by the transmission weight multiplication unit 306. Suppose the modulated signal of the kth subcarrier modulated by the modulation unit 304a is s₁^{(k)} and the modulated signal of the kth subcarrier modulated by the modulation unit 304b is s₂^{(k)}. Since the respective modulated signals are processed by the three radio units 309a to 309c, they are multiplied by three transmission weights. As a result, the signal outputted by the transmission weight multiplication unit 306 to the inverse Fourier transform unit n (n=1, 2, 3) can be expressed by following Formula (1). n=1 corresponds to the inverse Fourier transform unit 307a, n=2 corresponds to the inverse Fourier transform unit 307b and n=3 corresponds to the inverse Fourier transform unit 307c.

$${x}_{n}^{( k )} = {w}_{1 , n}^{( k )} \cdot {s}_{1}^{( k )} + {w}_{2 , n}^{( k )} \cdot {s}_{2}^{( k )} \qquad [ Formula 1 ]$$

Therefore, a transmission signal vector, elements of which are signals to be outputted to the inverse Fourier transform units 307a to 307c of the kth subcarrier, can be expressed as shown in following Formula (2).

$$\begin{matrix}{x}^{( k )} = [ {x}_{1}^{( k )} , {x}_{2}^{( k )} , {x}_{3}^{( k )} ] \\ = {w}_{1}^{( k )} \cdot {s}_{1}^{( k )} + {w}_{2}^{( k )} \cdot {s}_{2}^{( k )} \\ = [ {w}_{1}^{( k )} , {w}_{2}^{( k )} ] [ \begin{matrix}{s}_{1}^{( k )} \\ {s}_{2}^{( k )}\end{matrix} ] \\ = {W}^{( k )} [ \begin{matrix}{s}_{1}^{( k )} \\ {s}_{2}^{( k )}\end{matrix} ]\end{matrix} \qquad [ Formula 2 ]$$

Here, W^{(k)} is a weight matrix and the respective elements can be expressed by following Formula (3).

$${w}_{1}^{( k )} = {[ \begin{matrix}{w}_{1 , 1}^{( k )} , & {w}_{1 , 2}^{( k )} , & {w}_{1 , 3}^{( k )}\end{matrix} ]}^{T} \\ {w}_{2}^{( k )} = {[ \begin{matrix}{w}_{2 , 1}^{( k )} , & {w}_{2 , 2}^{( k )} , & {w}_{2 , 3}^{( k )}\end{matrix} ]}^{T} \qquad [ Formula 3 ]$$

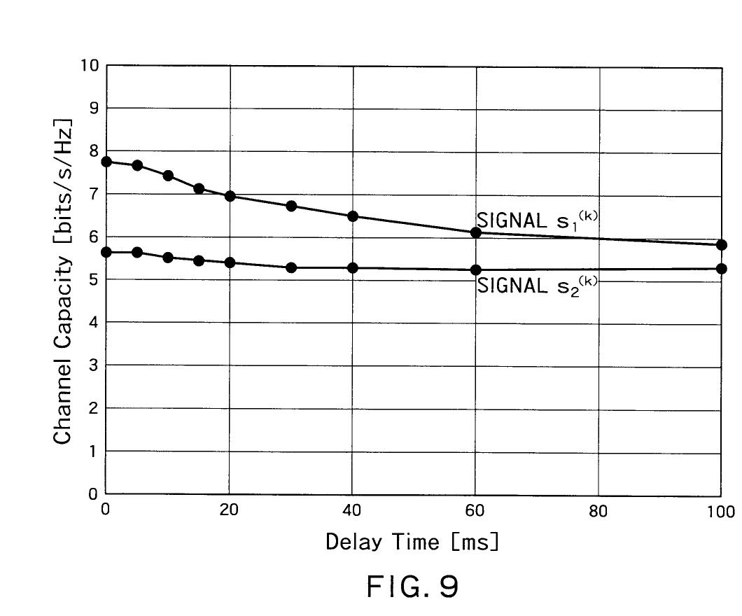

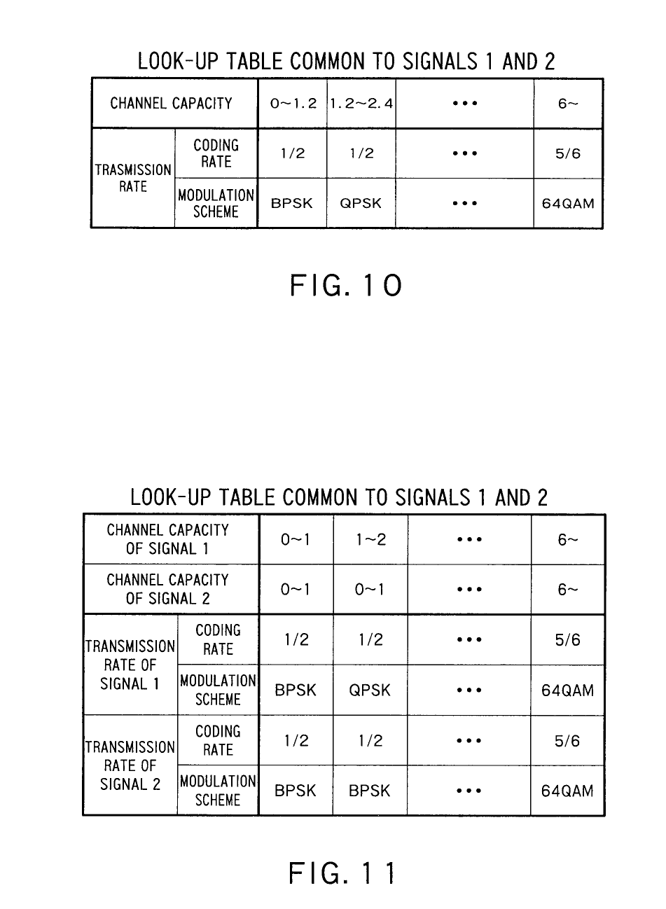

Here, []^{T} means transposing. An output signal xₙ^{(k)} from the transmission weight multiplication unit 306 is inputted to the inverse Fourier transform units 307. The technique of determining transmission weights will be explained later right after explaining a technique of determining a channel response with reference to FIG. 9 and FIG. 10.

### (Detailed Explanation of Channel Response Estimation)

Next, estimation of a channel response will be explained with reference to FIG. 7 and FIG. 8. As shown in FIG. 7, the reception terminal which reports a channel response to the radio communication apparatus of this embodiment is provided with reception antennas 701 (701a, 701b, 701c), radio units 702 (702a, 702b, 702c), GI elimination units 703 (703a, 703b, 703c), Fourier transform units 704 (704a, 704b, 704c) and a channel response estimation unit 705.

The radio units 702 convert signals received through the respective reception antennas 701 to digital signals. Since the respective radio units 702a to 702c are general radio sets made up of a low noise amplifier, a frequency converter, an analog/digital (A/D) converter and a filter, detailed explanations thereof will be omitted.

The GI elimination units 703 eliminate guard intervals from digital signals which are the output signals from the respective radio units 702.

The Fourier transform units 704a to 704c apply discrete Fourier transform to the signals outputted from the GI elimination units 703a to 703c to transform the signals to frequency domain signals. Here, the Fourier transform units 704 need only to perform discrete Fourier transform and may use FFT (Fast Fourier Transform) or DFT (Discrete Fourier Transform).

The channel response estimation unit 705 estimates a channel response based on the output signals of the Fourier transform units 704. This will be explained in detail below.

When the subcarrier k of a signal received by a reception antenna m and a radio unit m of the reception terminal for receiving a transmission signal, subjected to FFT transform into a frequency domain signal after GI elimination is assumed to be yₘ^{(k)}, a reception vector y^{(k)}, elements of which are the received signals from the respective radio units 702a to 702c can be expressed by following Formula (4). Here, m=1 corresponds to the reception antenna 701a and the radio unit 702a, m=2 corresponds to the reception antenna 701b and radio unit 702b and m=3 corresponds to the reception antenna 701c and radio unit 702c.

$$\begin{matrix}{y}^{( k )} = {[ \begin{matrix}{y}_{1}^{( k )} , & {y}_{2}^{( k )} , & {y}_{3}^{( k )}\end{matrix} ]}^{T} \\ = {H}^{( k )} {x}^{( k )} + {n}^{( k )}\end{matrix} \qquad [ Formula 4 ]$$

Here, n^{(k)} is a noise vector representing noise in the respective radio units 702, elements of which are included in the reception terminal. In Formula (4), an example where the number of radio units of the reception terminal is three is shown, but the number of radio units of the reception terminal of the present invention is not limited to three. Any number of reception radio units is acceptable as far as signals multiplexed and transmitted by the radio communication apparatus can be received.

H^{(k)} in Formula (4) is a channel matrix of the kth subcarrier, elements of which are channel responses between the transmission and reception terminals. The dimension of this channel matrix is (the number of reception radio units of the reception terminal)×(the number of transmission radio units used in the radio communication apparatus). The examples in FIG. 7 and FIG. 8 which will be described later are cases where the number of transmission radio units of the radio communication apparatus is three and the number of reception radio units of the reception terminal is three, and therefore the channel response matrix of the kth subcarrier is a matrix of 3×3.

Generally, in radio communication, when the channel response matrix H^{(k)} is unknown, received signals cannot be demodulated. Therefore, the radio communication apparatus transmits signals known to the reception terminal as the transmission signal x^{(k)} expressed by Formula (4) for channel response estimation. As a result, the channel response estimation unit 705 can estimate the channel response H^{(k)} using y^{(k)} and x^{(k)} obtained.

Next, as an example different from FIG. 7 of the channel response estimation unit at the reception terminal which reports channel responses to the radio communication apparatus of this embodiment, a scheme of estimating impulse responses and applying Fourier transform to the impulse responses will be explained with reference to FIG. 8.

The reception terminal which feeds back an estimated channel response matrix to the radio communication apparatus of this embodiment is constructed of reception antennas 701 (701a, 701b, 701c), radio units 702 (702a, 702b, 702c), impulse response estimation units 803 (803a, 803b, 803c) and Fourier transform units 704 (704a, 704b, 704c) as shown in FIG. 8. The same parts as those in the reception terminal in FIG. 7 are assigned the same reference numerals and explanations thereof will be omitted. The impulse response estimation units 803a to 803c receive digital signals which are output signals from the radio units 702 and estimate impulse responses from these digital signals. The impulse responses estimated by the impulse response estimation units 803a to 803c are subjected to Fourier transform and a channel response matrix is thereby obtained. In FIG. 8, FFT is used as Fourier transform, but Fourier transform in this embodiment is not limited to FFT. Any scheme may be used as far as it can transform time domain signals to frequency domain signals.

As explained with reference to FIG. 7, impulse responses are estimated using known signals transmitted by the radio communication apparatus here, too. Examples of the scheme whereby the impulse response estimation units 803 estimate impulse responses from known signals include a scheme using a least squares method and a minimum mean squared error method, but since these do not constitute the essence of this embodiment, detailed explanations thereof will be omitted. Furthermore, the estimation scheme in the impulse response estimation units 803 is not limited to the least squares method and minimum mean squared error method. The impulse response estimation units 803 may use any estimation scheme as far as it allows impulse responses to be estimated.

As shown with reference to FIG. 7 and FIG. 8 above, channel responses can be reported to the radio communication apparatus by using the channel responses obtained by the reception terminal as data and transmitting the data to the radio communication apparatus. In this way, the reception terminal feeds back the estimated channel responses to the radio communication apparatus and the radio communication apparatus can thereby know the channel responses.

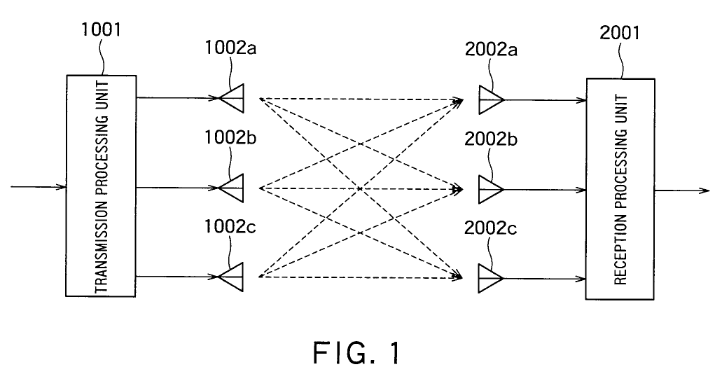

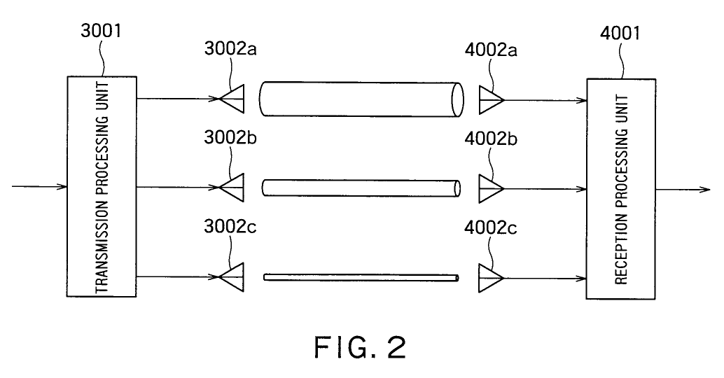

On the other hand, the radio communication apparatus and the reception terminal mutually repeat transmission and reception as described above, and therefore the radio communication apparatus may also receive transmission signals from the reception terminal. In this case, it is possible to estimate channel responses from the reception terminal to the radio communication apparatus according to the technique explained with reference to FIG. 7 and FIG. 8 using known signals for channel response estimation added to the signals. The channel responses are estimated by the radio communication apparatus, for example, at the channel response acquisition unit in the transmission weight generation unit in FIG. 1. When frequencies used for communication are identical frequencies, there may be a slight difference due to a performance difference between the radio communication apparatus and the reception terminal, but the channel response from the reception terminal to the radio communication apparatus is substantially equivalent to the channel response from the radio communication apparatus to the reception terminal. Therefore, it is possible to estimate a channel response during transmission from the channel response estimated during reception.

In this way, there may be several methods whereby the radio communication apparatus makes channel responses known, but the radio communication apparatus in this embodiment is by no means intended to limit the technique of acquiring channel responses and any technique can be used.

### (Example of Generating Transmission Weight)

Next, a technique of generating transmission weights based on the channel responses obtained as described above will be explained. Transmission weighs are determined by the transmission weight generation unit 305.

The respective weight vectors w₁^{(k)} and w₂^{(k)} corresponding to the radio communication apparatus in FIG. 3 are known to be able to be optimized by decomposing the channel response matrix through singular value decomposition (hereinafter referred to as “SVD”) and the channel response matrix H^{(k)} can be expressed by SVD as shown in following Formula (5).

$$\begin{matrix}{H}^{( k )} = {U}^{( k )} {D}^{( k )} {V}^{( k ) H} \\ = [ \begin{matrix}{u}_{1}^{( k )} , & {u}_{2}^{( k )} , & {u}_{3}^{( k )}\end{matrix} ] diag [ \sqrt{{λ}_{1}^{( k )} ,} \sqrt{{λ}_{2}^{( k )} ,} \sqrt{{λ}_{3}^{( k )}} ] \\ [ \begin{matrix}{v}_{1}^{( k ) H} \\ {v}_{2}^{( k ) H} \\ {v}_{3}^{( k ) H}\end{matrix} ] \\ = \sqrt{{λ}_{1}^{( k )}} {u}_{1}^{( k )} {v}_{1}^{( k ) H} + \sqrt{{λ}_{2}^{( k )}} {u}_{2}^{( k )} {v}_{2}^{( k ) H} + \sqrt{{λ}_{3}^{( k )}} {u}_{3}^{( k )} {v}_{3}^{( k ) H}\end{matrix} \qquad [ Formula 5 ]$$

Here, []^{H} represents complex conjugate transposition and diag[] represents a diagonal matrix. Furthermore, u₁^{(k)}, u₂^{(k)} and u₃^{(k)} are vectors, the number of elements of which is equal to the number of reception radio units of the reception terminal and v₁^{(k)}, v₂^{(k)} and v₃^{(k)} are vectors, the number of elements of which is equal to the number of transmission radio units of the radio communication apparatus, and are orthogonal vectors that satisfy following Formula (6) (Formulas (6-1) and (6-2)).

$$\begin{matrix}{v}_{i}^{( k ) H} {v}_{i}^{( k )} = {δ}_{ij} & [ Formula 6 \text{-} 1 ] \\ {u}_{i}^{( k ) H} {u}_{i}^{( k )} = {δ}_{ij} & [ Formula 6 \text{-} 2 ]\end{matrix}$$

wHere, δᵢⱼ is Kronecker's delta expressed by following Formula (7).

$${δ}_{ij} = \{ \begin{matrix}1 ( i = j ) \\ 0 ( i \neq j )\end{matrix} \qquad [ Formula 7 ]$$

The radio communication apparatus uses the v₁^{(k)}, v₂^{(k)} and v₃^{(k)} obtained as shown above as transmission weights and multiplies the output signal from the modulation units 304 by the v₁^{(k)}, v₂^{(k)} and V₃^{(k)}. When v₁^{(k)} ((w₁^{(k)}=v₁^{(k)}) is applied as the transmission weight of the transmission signal s₁^{(k)} and v₂^{(k)} (w₂^{(k)}=v₂^{(k)}) is applied as the transmission weight of the transmission signal s₂^{(k)}, the received signal of Formula (4) can be expressed by following Formula (8).

$${y}^{( k )} = \sqrt{{λ}_{1}^{( k )}} {u}_{1}^{( k )} {s}_{1}^{( k )} + \sqrt{{λ}_{2}^{( k )}} {u}_{2}^{( k )} {s}_{2}^{( k )} + {n}^{( k )} \qquad [ Formula 8 ]$$

Since u₁^{(k)} and u₂^{(k)} are orthogonal to each other from Formula (6), s₁^{(k)} and s₂^{(k)} can be extracted by multiplying the received signal y^{(k)} by u₁^{(k)H} and u₂^{(k)H} as shown in following Formula (9) (Formulas (9-1) and (9-2)).

$$\begin{matrix}{s}_{1}^{( k )} \approx {u}_{1}^{( k ) H} \cdot {y}_{1}^{( k )} / \sqrt{{λ}_{1}^{( k )}} & [ Formula 9 \text{-} 1 ] \\ {s}_{2}^{( k )} \approx {u}_{2}^{( k ) H} \cdot {y}_{2}^{( k )} / \sqrt{{λ}_{2}^{( k )}} & [ Formula 9 \text{-} 2 ]\end{matrix}$$

Other examples of the technique of extracting signals transmitted from the received signal include a ZF method of multiplying an inverse matrix for generalizing a channel response matrix, an MMSE of multiplying a weight matrix that minimizes a root-mean-square value of an error and a scheme of performing maximum likelihood estimation using a replica signal. This embodiment is not intended to limit the reception unit to a specific technique and any techniques including or other than the above described techniques may be used.

### (Explanation of Channel Capacity)

The channel capacities c₁^{(k)} and c₂^{(k)} at the reception terminal of the signals s₁^{(k)} and s₂^{(k)} extracted from the received signal as shown above can be expressed by following Formula (10) (Formulas (10-1) and (10-2)). The channel capacity refers to a maximum achievable transmission rate per unit time. The channel capacity may be calculated by the reception terminal or the transmission rate control unit 301 of the radio communication apparatus in FIG. 3 as will be described later. The channel capacity is an example of metric (used to control a transmission rate) for evaluating the transmission characteristic of a signal and other parameters may also be used as the metric.

$$\begin{matrix}Channel capacity {c}_{1}^{( k )} of {s}_{1}^{( k )} \text{:} {log}_{2} ( 1 + \frac{\vert {s}_{1}^{( k )} \vert}{{‖ {n}^{( k )} ‖}^{2}} {λ}_{1}^{( k )} ) & [ Formula 10 \text{-} 1 ] \\ Channel capacity {c}_{2}^{( k )} of {s}_{2}^{( k )} \text{:} {log}_{2} ( 1 + \frac{\vert {s}_{2}^{( k )} \vert}{{‖ {n}^{( k )} ‖}^{2}} {λ}_{2}^{( k )} ) & [ Formula 10 \text{-} 2 ]\end{matrix}$$

Here, symbols ∥∥ that enclose n^{(k)} represent a square norm of a vector. Since the average power of signals s₁^{(k)} and s₂^{(k)} is constant irrespective of signals to be multiplexed, it is apparent that the channel capacities c₁^{(k)} and c₂^{(k)} of the subcarrier k for each multiplexed signal are determined by singular values λ₁^{(k)} and λ₂^{(k)} of the channel response matrix of the subcarrier k. Singular values of the channel response matrix generally have different values, and therefore the channel capacity varies from one signal to be multiplexed to another. Furthermore, in a radio environment in which a plurality of multiple waves arrive at different times, the channel response matrix varies from one subcarrier to another, and therefore the channel capacity also varies from one subcarrier to another.

When transmission weight vectors having a large singular value are assigned to only signals modulated by specific modulation units of all subcarriers, that is, λ₁^{(k)}≧λ₂^{(k)} is assumed and the transmission weight vector w₁^{(k)} of the signal s₁^{(k)} is assumed to be v₁^{(k)}, the channel capacity of the signal modulated by the modulation unit 304a in FIG. 3 is greater than the channel capacity of the signal modulated by the modulation unit 304b for all subcarriers, producing a disparity in transmission quality between the signal modulated by the modulation unit 304a and the signal modulated by the modulation unit 304b.

Therefore, to efficiently perform communication in such an environment, it is preferable to assign transmission rates of the respective signals s₁^{(k)} and s₂^{(k)} according to the channel capacity. For example, a high transmission rate is assigned to a signal having a large channel capacity and a low transmission rate is assigned to a signal having a small channel capacity. To increase the transmission rate, the coding rate may be increased or the multivalue number of the modulation scheme may be increased. Furthermore, to lower the transmission rate, the coding rate may be decreased or the multivalue number of the modulation scheme may be decreased.

From above, when a channel response to/from the reception terminal is known, the radio communication apparatus of this embodiment assigns an optimum transmission rate to each signal according to the channel capacity calculated based on the channel response, and can thereby obtain an effect of improving the throughput.

### (Problem of Assignment Error Due to Delay)

However, the channel response reported from the above described reception terminal to the radio communication apparatus may not always match the actual channel response when the radio communication apparatus carries out transmission. In general, since the radio channel varies with time, if an elapsed time after a channel response is reported to the radio communication apparatus (may also be defined as an elapsed time after the reception terminal estimates the channel response. Hereinafter, these may be collectively referred to as a “delay time”) increases, the time variation of the channel can no longer be ignored and a known channel response may be different from the actual channel response at the radio communication apparatus.

Before the radio communication apparatus multiplies a data packet by a transmission weight and sends the data packet, the time variation of the channel can be generally ignored by realizing such packet switching that the radio communication apparatus sends a known signal for channel response estimation to the reception terminal and the reception terminal reports a channel response estimation result to the radio communication apparatus, and therefore the transmission weight generated by the radio communication apparatus based on the known channel response is also optimum for the actual channel. However, if the radio communication apparatus realizes packet switching to acquire a channel response every time the radio communication apparatus sends a packet, there is a problem that overhead increases and the throughput decreases.

Therefore, in realistic terms, the radio communication apparatus realizes packet switching to acquire a channel response once, carries out transmission processing using the same channel response and transmission weights generated based on the channel response across a plurality of data packets, and can thereby decrease the overhead. In such a situation, if the elapsed time after the channel response is estimated increases, the transmission weight generated from a channel response known to the radio communication apparatus does not become any optimum directional beam for the actual channel. As a result, the respective signals s₁^{(k)} and s₂^{(k)} transmitted from the radio communication apparatus using the transmission beam produce interference between the respective signals. This also influences the channel capacities c₁^{(k)} and c₂^{(k)} of the signals s₁^{(k)} and s₂^{(k)} extracted from the received signal at the reception terminal. Since the channel capacity obtained when the channel response known to the radio communication apparatus matches the actual channel is different from the channel capacity obtained when the channel response known to the radio communication apparatus does not match the actual channel, although the channel response known to the radio communication apparatus is different from the actual channel, if the channel response known to the radio communication apparatus is judged to match the actual channel and the transmission rate of each signal is assigned according to the channel capacity of each signal obtained based on the channel response known to the radio communication apparatus, the assigned transmission rate ceases to be optimum. Especially when a higher transmission rate than the optimum transmission rate is assigned, packet errors and accompanying packet retransmissions may frequently occur and the throughput may deteriorate consequently.

Therefore, in order for the radio communication apparatus to avoid transmission rate assignment errors due to time variations of the channel and improve the throughput to acquire a channel response while reducing overhead by packet switching, the transmission rate must be assigned by taking into consideration the variation characteristic of the channel capacity (metric) with respect to the delay time.

### (Explanation of Proposed Method)

FIG. 9 shows the variation characteristics of channel capacities of the signals s₁^{(k)} and s₂^{(k)} with respect to the delay time in the apparatus configuration explained in this embodiment (the number of transmission radio units of the radio communication apparatus is 3, the number of transmission signals is 2, the number of reception radio units of the reception terminal is 3). This variation characteristic graph has been obtained based on the result of a simulation independently conducted by the inventor of the present invention. The horizontal axis shows a delay time and the vertical axis shows a channel capacity. From FIG. 9, in an ideal case without any delay, that is, when the delay time is 0 [ms], the channel capacity c₁^{(k)} of the signal s₁^{(k)} takes a greater value than the channel capacity c₂^{(k)} of the signal s₂^{(k)}, but it is apparent that the channel capacity c₁^{(k)} of the signal s₁^{(k)} deteriorates as the delay time increases and reaches substantially the same level as a convergence value (worst value) of the channel capacity c₂^{(k)} of the signal S₂^{(k)}. Furthermore, it is also apparent that the channel capacity c₂^{(k)} of the signal s₂^{(k)} assumes substantially the same value regardless of the delay time. That is, it is apparent that the channel capacity c₂^{(k)} of the signal s₂^{(k)} fluctuates little independently of the delay time.

Therefore, according to the embodiment of the present invention, the transmission rate control unit 301 performs control so that the transmission rate of each signal is determined on the basis of a signal for which the variation characteristic of the channel capacity with respect to a delay time becomes substantially constant (signal with little variation of the channel capacity with respect to a delay time), and can thereby avoid transmission rate assignment errors and prevent deterioration of the throughput even when the radio communication apparatus uses a channel response which has been acquired once across a plurality of packets.

### (Transmission Rate Control Method of First Embodiment)

Hereinafter, a more specific transmission rate control method of this embodiment will be explained. In the case of an OFDM-based system, the transmission rate assignment method can be roughly divided into a case where different transmission rates are assigned to different subcarriers and a case where a common transmission rate is assigned to all subcarriers, and therefore the former will be explained in this embodiment and the latter will be explained in a second embodiment separately.

### (Determination of C2)

[1] First of all, the transmission rate control unit 301 will determine the channel capacity c₂^{(k)} of the signal s₂^{(k)}

To determine the channel capacity c₂^{(k)} of the signal s₂^{(k)}, the transmission weight generation unit 305 may send a singular value calculated by decomposing the channel response reported from the reception terminal into singular values as a transmission rate control signal 313 to the transmission rate control unit 301 and the transmission rate control unit 301 may calculate the channel capacity c₂^{(k)} using Formula (10-2). Furthermore, the transmission rate control signal 313 may also send a channel response or transmission weight to the transmission rate control unit 301 and calculate the channel capacity using a ZF norm as shown in Formula (11) or calculate the channel capacity using an MMSE norm as shown in Formula (12).

$$\begin{matrix}{c}_{2}^{( k )} = [ {log}_{2} ( \frac{\vert {s}_{2}^{( k )} \vert / {‖ {n}^{( k )} ‖}^{2}}{{N}_{t} {w}_{2}^{H} {w}_{2}} + 1 ) ] & [ Formula 11 ] \\ {c}_{2}^{( k )} = {log}_{2} ( \{ 1 - {( {Hw}_{2} )}^{H} ( \begin{matrix}{{Hw}_{2} ( {Hw}_{2} )}^{H} + \\ \frac{{N}_{t} {I}_{{N}_{r}}}{{‖ {n}^{( k )} ‖}^{2}}\end{matrix} ) \} {Hw}_{2} ) & [ Formula 12 ]\end{matrix}$$

Here, the channel capacity calculation method according to this embodiment is not limited to the method explained above. Any method may be used as far as it allows the radio communication apparatus to calculate anything that can be handled as a channel capacity.

### (Determination of C1)

[2] Next, the channel capacity c₁^{(k)} of the signal s₁^{(k)} will be determined on the basis of the channel capacity c₂^{(k)} of the signal s₂^{(k)} calculated by the transmission rate control unit 301. Details of the method of determining the channel capacity c₁^{(k)} will be described later.

### (Determination of Transmission Rate)

[3] Next, the channel capacities c₁^{(k)} and c₂^{(k)} determined by the transmission rate control unit 301 are inputted as the metric signal 311 to the storage 302. The storage 302 stores a Look-Up Table (hereinafter referred to as “LUT”) showing a relationship between channel capacities and transmission rates, selects a transmission rate from an inputted channel capacity with reference to the LUT and reports the selected transmission rate as the selected transmission rate signal 312 to the transmission rate control unit 301.

The above described LUT showing the relationship between channel capacities and transmission rates may be created based on a characteristic acquired beforehand (e.g., channel capacity versus bit error rate characteristic, channel capacity versus packet error rate characteristic).

### (Detailed Explanation of [2] and [3])

Here, the method of selecting a transmission rate from the metric signal 311 inputted to the storage 302 explained in [3] with reference to the LUT will be explained together with the method of determining the channel capacity c₁^{(k)} of the signal s₁^{(k)} from the channel capacity c₂^{(k)} of the signal s₂^{(k)} explained in [2].

### (Assignment of Transmission Rate on a Per Subcarrier Basis, Premised on Coding Configuration in FIG. 4, Common LUT)

(Method 1) Suppose the channel capacity c₁^{(k)} of the signal s₁^{(k)} is (channel capacity c₁^{(k)} of signal s₁^{(k)})=(channel capacity c₂^{(k)} of signal s₂^{(k)}). With reference to a LUT common to the signal s₁ and signal s₂ as shown in FIG. 11, transmission rates corresponding to the respective values of the channel capacities c₁^{(k)} and c₂^{(k)} are assigned to the signals s₁^{(k)} and s₂^{(k)}.

### (Assignment of Transmission Rate on a Per Subcarrier Basis, Premised on Coding Configuration in FIG. 5, Common LUT)

(Method 2) Suppose the channel capacity c₁^{(k)} of the signal s₁^{(k)} is (channel capacity c₁^{(k)} of signal s₁^{(k)})=(channel capacity c₂^{(k)} of signal s₂^{(k)}). With reference to a LUT common to the signal s₁ and signal s₂ as shown in FIG. 11, the corresponding transmission rates are assigned to the signals s₁^{(k)} and s₂^{(k)} from the correlation between the values of the channel capacities c₁^{(k)} and c₂^{(k)}.

### (Assignment of Transmission Rate on a Per Subcarrier Basis, Premised on Coding Configuration in FIG. 5, Common LUT)

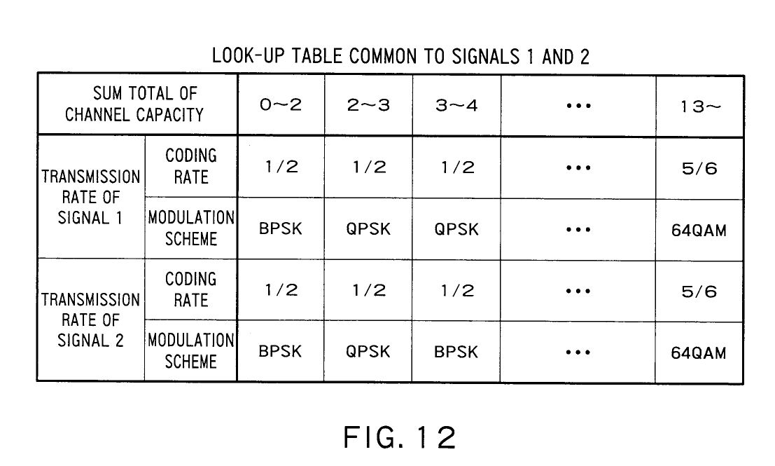

(Method 3) Suppose the channel capacity c₁^{(k)} of the signal s₁^{(k)} is (channel capacity c₁^{(k)} of signal s₁^{(k)})=(channel capacity c₂^{(k)} of signal s₂^{(k)}). With reference to a LUT shown in FIG. 12, the corresponding transmission rates are assigned from the sum total of the values of the channel capacities c₁^{(k)} and c₂^{(k)} to the signals S₁^{(k)} and s₂^{(k)}.

### Effects of First Embodiment

As explained so far, this embodiment performs transmission rate control on the basis of a signal for which the variation characteristic of a metric (channel capacity) of transmission rate control with respect to a delay time becomes substantially constant (signal with little variation of channel capacity with respect to a delay time), and can thereby reduce overhead for the radio communication apparatus to acquire a channel response, at the same time avoid errors in transmission rate assignment for a lapse of time after acquiring the channel response and improve the throughput of the entire system.

### Second Embodiment

A radio communication apparatus according to this embodiment has the same configuration as that in FIG. 3, and is also similar to the first embodiment in that a weight vector is determined based on a channel response and transmission is performed by multiplexing signals using directional beams which vary from one subcarrier to another and transmission rate control is performed on the basis of a signal for which a variation characteristic of a metric of transmission rate control with respect to a delay time becomes substantially constant. This embodiment differs from the first embodiment in performing transmission rate control by assigning a transmission rate common to all subcarriers instead of assigning different transmission rates to different subcarriers.

Depending on the system, different transmission rates can not always be assigned to different subcarriers and there may be cases where a transmission rate common to all subcarriers must be assigned. In such a case, there is a method of determining a transmission rate from a representative value that represents channel capacities of all subcarriers (mean value or central value or the like; hereinafter a mean value will be assumed), for example, and assigning a common transmission rate to all subcarriers. Hereinafter, a more specific transmission rate control method of this embodiment will be explained.

### (Transmission Rate Control Method of Second Embodiment)

Hereinafter, a more specific transmission rate control method of this embodiment will be explained.

### (Determination of C2)

[1] First of all, the transmission rate control unit 301 calculates a channel capacity c₂^{(k)} of a signal s₂^{(k)} of each subcarrier and calculates a channel capacity \tilde{c}₂ averaged among all subcarriers.

To calculate the channel capacity c₂^{(k)} of the signal s₂^{(k)}, singular values obtained by the transmission weight generation unit 305 by applying singular value decomposition to a channel response reported from the reception terminal may be sent as a transmission rate control signal 313 to the transmission rate control unit 301 and the transmission rate control unit 301 may calculate the channel capacity c₂^{(k)} using Formula (10-2). Furthermore, a channel response or transmission weight may also be sent with the transmission rate control signal 313 to the transmission rate control unit 301 and the channel capacity may be calculated using a ZF norm as shown in Formula (11) or an MMSE norm as shown in Formula (12). Here, the channel capacity calculation method of this embodiment is not limited to the above described method. Any method may be used as far as it allows the radio communication apparatus to calculate anything that can be handled as a channel capacity.

### (Determination of C1)

[2] Next, an average channel capacity \tilde{c}₁ of the signal s₁ will be determined on the basis of the average channel capacity \tilde{c}₂ of the signal s₂ calculated by the transmission rate control unit 301.

### (Determination of Transmission Rate)

[3] Next, the average channel capacities \tilde{c}₁ and \tilde{c}₂ calculated by the transmission rate control unit 301 are inputted as the metric signal 311 to the storage 302. The storage 302 stores a LUT showing a relationship between channel capacities and transmission rates, selects a transmission rate based on an inputted channel capacity with reference to the LUT and reports the selected transmission rate as the selected transmission rate signal 312 to the transmission rate control unit 301.

The above described LUT showing the relationship between channel capacities and transmission rates may be created based on a characteristic acquired beforehand (e.g., channel capacity versus bit error rate characteristic, channel capacity versus packet error rate characteristic).

### (Detailed Explanation of [2] and [3])

Here, the method of selecting a transmission rate from the metric signal 311 inputted to the storage 302 explained in [3] with reference to the LUT will be explained together with the method of determining the average channel capacity \tilde{c}₁ of the signal s₁ from the average channel capacity \tilde{c}₂ of the signal s₂ explained in [2].

### (Assignment of the Same Transmission Rate to all Subcarriers, Premised on Coding Configuration in FIG. 4, Common LUT)

(Method 4) Suppose average channel capacity \tilde{c}₁ of the signal s₁ is (average channel capacity \tilde{c}₁ of signal s₁)=(average channel capacity \tilde{c}₂ of signal s₂). With reference to a LUT common to the signal s₁ and signal s₂ as shown in FIG. 10, transmission rates corresponding to the respective values of the channel capacities \tilde{c}₁ and \tilde{c}₂ are assigned to the signals s₁ and s₂.

### (Assignment of the Same Transmission Rate to all Subcarriers, Premised on Coding Configuration in FIG. 4, Individual LUTs)

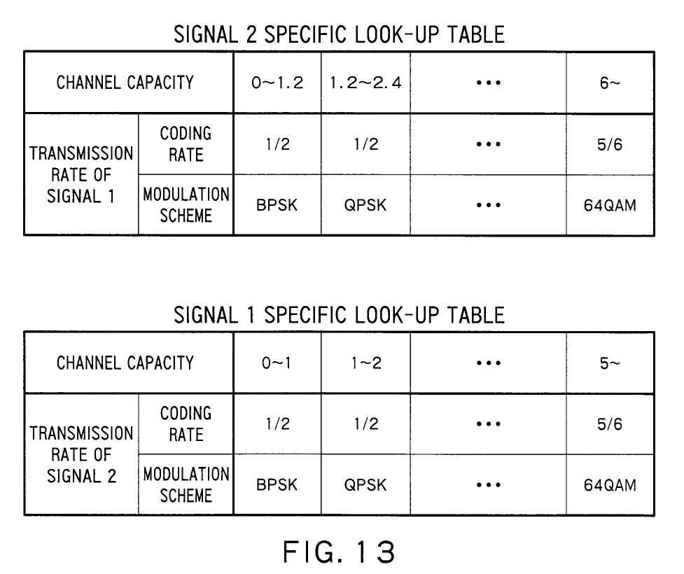

(Method 5) Suppose the average channel capacity \tilde{c}₁ of the signal s₁ is (average channel capacity \tilde{c}₁ of signal s₁)=(average channel capacity \tilde{c}₂ of signal s₂). Taking into consideration the fact that the distribution of channel capacities of all subcarriers of a higher signal (signal s₁) is smaller than the distribution of channel capacities of all subcarriers of a lower signal (signal s₂) and the higher signal has a better transmission characteristic when all subcarriers are assigned the same transmission rate, transmission rates corresponding to the values of channel capacities \tilde{c}₁ and \tilde{c}₂ are assigned to signals s₁ and s₂ with reference to individual LUTs of the signal s₁ and signal s₂ as shown in FIG. 13.

### (Assignment of the Same Transmission Rate to all Subcarriers, Premised on Coding Configuration in FIG. 4, Common LUT)

(Method 6) Taking into consideration the fact that the distribution of channel capacities of all subcarriers of a higher signal (signal s₁) is smaller than the distribution of channel capacities of all subcarriers of a lower signal (signal s₂) and the higher signal has a better transmission characteristic when the same transmission rate is assigned to all subcarriers, the average channel capacity \tilde{c}₁ of the signal s₁ is assumed to be (average channel capacity \tilde{c}₁ of signal s₁)=(average channel capacity \tilde{c}₂ of signal s₂+□), an amount of advantage α[bit/s/Hz] is given to the signal s₁, and transmission rates corresponding to the values of channel capacities \tilde{c}₁ and \tilde{c}₂ are assigned to the signals s₁ and s₂ with reference to the LUT common to the signal s₁ and signal s₂ as shown in FIG. 10.

### (Assignment of the Same Transmission Rate to all Subcarriers, Premised on Coding Configuration in FIG. 5, Common LUT)

(Method 7) Suppose the average channel capacity \tilde{c}₁ of the signal s₁ is (average channel capacity \tilde{c}₁ of signal s₁)=(average channel capacity \tilde{c}₂ of signal s₂). With reference to the LUT common to the signal s₁ and signal s₂ as shown in FIG. 11, corresponding transmission rates are assigned to the signals s₁ and s₂ from the correlation between the values of channel capacities \tilde{c}₁ and \tilde{c}₂.

### (Assignment of the Same Transmission Rate to all Subcarriers, Premised on Coding Configuration in FIG. 5, Common LUT)

(Method 8) Suppose the average channel capacity \tilde{c}₁ of the signal s₁ is (average channel capacity \tilde{c}₁ of signal s₁)=(average channel capacity \tilde{c}₂ of signal s₂). With reference to the LUT common to the signal s₁ and signal s₂ as shown in FIG. 12, transmission rates are assigned to the signals s₁ and s₂ from the sum total of the values of the channel capacities \tilde{c}₁ and \tilde{c}₂.

### (Assignment of the Same Transmission Rate to all Subcarriers, Premised on Coding Configuration in FIG. 5, Common LUT)

(Method 9) Taking into consideration the fact that the distribution of channel capacities of all subcarriers of a higher signal (signal s₁) is smaller than the distribution of channel capacities of all subcarriers of a lower signal (signal s₂) and the higher signal has a better transmission characteristic when all subcarriers are assigned the same transmission rate, the average channel capacity \tilde{c}₁ of the signal s₁ is assumed to be (average channel capacity \tilde{c}₁ of signal s₁)=(average channel capacity \tilde{c}₂ of signal s₂+α), an amount of advantage α[bit/s/Hz] is given to the signal s₁, and with reference to the LUT common to the signal s₁ and signal s₂ as shown in FIG. 11, corresponding transmission rates are assigned to the signals s₁ and s₂ from the correlation between the values of the channel capacities \tilde{c}₁ and \tilde{c}₂.

Here, the method of selecting transmission rates from the Look-Up Table showing a relationship between channel capacities and transmission rates of this embodiment is not limited to the methods explained above. Any method may be used as far as it allows the radio communication apparatus to select a transmission rate on the basis of the channel capacity of the signal s₂ having little variation with respect to a delay time.

### Effects of Second Embodiment

As explained so far, this embodiment performs transmission rate control on the basis of a signal for which the variation characteristic of a metric of transmission rate control with respect to the delay time becomes substantially constant, and can thereby reduce overhead for the radio communication apparatus to acquire a channel response, avoid transmission rate assignment errors for an elapsed time after acquiring a channel response and improve the throughput of the entire system.

### Third Embodiment

A radio communication apparatus according to this embodiment has the same configuration as that in FIG. 3, is also similar to the first embodiment in that a weight vector is determined based on a channel response, signals are multiplexed using different directional beams for different subcarriers and transmitted and transmission rate control is performed on the basis of a signal for which the variation characteristic of a metric of transmission rate control with respect to a delay time becomes substantially constant. This embodiment differs from the first embodiment in that transmission rates are assigned in consideration of a spatial correlation when performing transmission rate control.

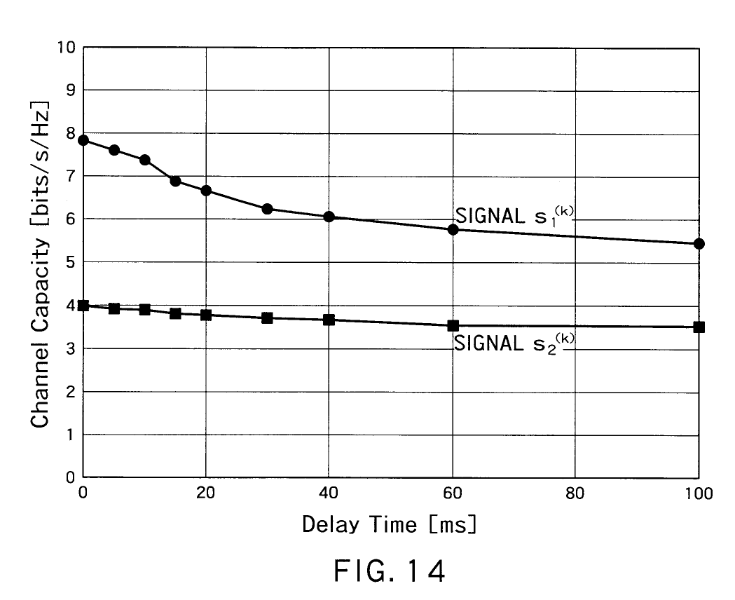

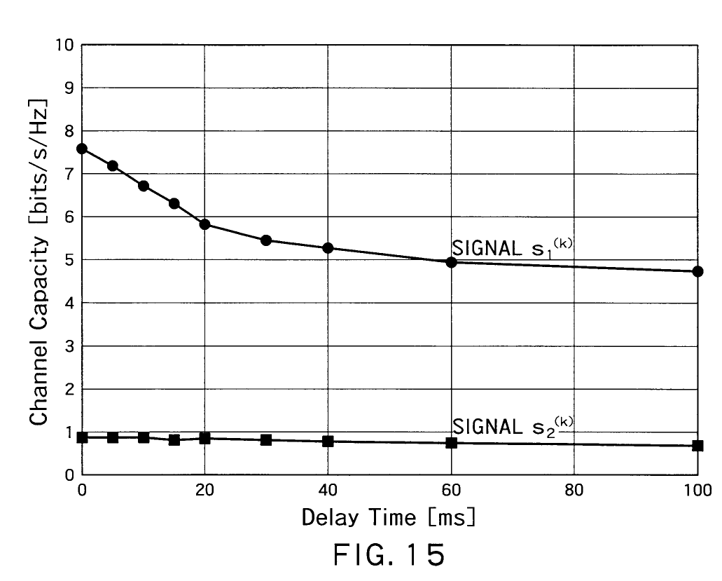

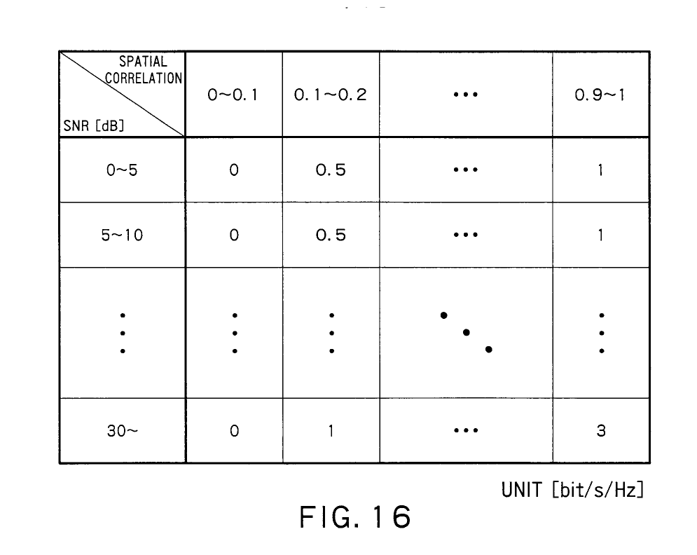

The delay time versus channel capacity characteristic shown in FIG. 9 corresponds to a case where the correlation of channel responses is small, but when, for example, the distance between antennas is small or in the case of line-of-sight communication, a spatial correlation among radio channels may increase. In such a case, the variation characteristics of channel capacities of the respective signals with respect to the delay time become as shown in FIG. 14 and FIG. 15. The characteristics shown in FIG. 9, FIG. 14 and FIG. 15 are based on the same SNR (Signal to Noise Ratio).

FIG. 14 shows a case where the spatial correlation is at a level of approximately 0.5 and FIG. 15 shows a case where the spatial correlation is at a level of approximately 0.9. As shown in FIG. 14 and FIG. 15, when the spatial correlation viewed from FIG. 9 cannot be ignored, it is apparent that when the spatial correlation increases, the convergence values (worst values) of the channel capacity c₁^{(k)} of the signal s₁^{(k)} and the channel capacity c₂^{(k)} of the signal s₂^{(k)} do not reach substantially the same level as shown in FIG. 9 and converge, with the characteristic difference remaining. As the factor determining the level of this characteristic difference, the spatial correlation becomes dominant.

Therefore, this embodiment takes into consideration the variation characteristics of channel capacities with respect to a delay time for each spatial correlation value when performing transmission rate control. A more specific transmission rate control method of this embodiment will be explained below. In the case of an OFDM-based system, the transmission rate assignment method can be roughly divided into a case where different transmission rates are assigned to different subcarriers and a case where a transmission rate common to all subcarriers is assigned, and therefore the former will be explained in this embodiment and the latter will be explained in a fourth embodiment separately.

### (Transmission Rate Control Method According to Third Embodiment)

### (Determination of C2)

[1] First of all, the transmission rate control unit 301 will determine the channel capacity c₂^{(k)} of the signal s₂^{(k)}. To determine the channel capacity c₂^{(k)} of the signal s₂^{(k)}, the transmission weight generation unit 305 may send a singular value calculated by decomposing a channel response reported from the reception terminal into singular values as the transmission rate control signal 313 to the transmission rate control unit 301 and the transmission rate control unit 301 may calculate the channel capacity c₂^{(k)} using Formula (10-2). Furthermore, the transmission rate control signal 313 may also send a channel response or transmission weight to the transmission rate control unit 301 and calculate the channel capacity using a ZF norm as shown in Formula (11) or calculate the channel capacity using an MMSE norm as shown in Formula (12). Here, the channel capacity calculation method according to this embodiment is not limited to the method explained above. Any method may be used as far as it allows the radio communication apparatus to calculate anything that can be handled as a channel capacity.

### (Determination of C1)

[2] Next, the channel capacity c₁^{(k)} of the signal s₁^{(k)} will be determined on the basis of the channel capacity c₂^{(k)} of the signal S₂^{(k)} obtained by the transmission rate control unit 301. When determining the channel capacity c₁^{(k)}, a table as shown in FIG. 16 is used which shows spatial correlations and disparities in convergence values (worst values) between the channel capacities of the second stream and the first stream. Since disparities in convergence values (worst values) of channel capacities between the second stream and first stream also vary depending on the SNR, the table in FIG. 16 stores values expressing disparities by SNR.

The spatial correlation may be calculated as H(k)*H(k)^{H} or H(k)^{H}*H(k) based on the channel response known to the radio communication apparatus or the transmission weight generation unit 305 may calculate a conditional number (maximum singular value/minimum singular value) using a maximum singular value and a minimum singular value obtained when carrying out singular value decomposition and use it as an index of spatial correlation. Here, the spatial correlation calculation method of this embodiment is not limited to the method explained above. Any method may be used as far as it allows the radio communication apparatus to calculate anything that can be handled as a spatial correlation. The transmission rate control unit 301 may also be provided with a spatial correlation acquisition unit that acquires a spatial correlation value.

In a communication mode in which transmission beam forming is performed, an SNR is generally reported together when a channel response is reported from the reception terminal to the radio communication apparatus. Therefore, the radio communication apparatus can make the SNR known. Furthermore, the radio communication apparatus may also estimate an SNR using a known signal added to a packet when the reception terminal reports a channel response to the radio communication apparatus. Since the SNR estimation method has no influence on the essence of the present invention, detailed explanations thereof will be omitted. The transmission rate control unit 301 may also be provided with an SNR acquisition unit which acquires an SNR.

### (Determination of Transmission Rate)

[3] Next, the channel capacities c₁^{(k)} and c₂^{(k)} determined by the transmission rate control unit 301 are inputted as the metric signal 311 to the storage 302. The storage 302 stores a LUT showing a relationship between channel capacities and transmission rates, selects a transmission rate from an inputted channel capacity with reference to the LUT and reports the selected transmission rate as the selected transmission rate signal 312 to the transmission rate control unit 301.

The LUT showing the relationship between the above described channel capacities and transmission rates may be created based on a characteristic acquired beforehand (e.g., channel capacity versus bit error rate characteristic, channel capacity versus packet error rate characteristic).

### (Detailed Explanation of [2] and [3])

Here, the method of selecting a transmission rate from the metric signal 311 inputted to the storage 302 explained in [3] with reference to the LUT will be explained in detail together with the method of determining the channel capacity c₁^{(k)} of the signal s₁^{(k)} from the channel capacity c₂^{(k)} of the signal s₂^{(k)} explained in [2].

### (Assignment of Transmission Rate on a Per Subcarrier Basis, Premised on Coding Configuration in FIG. 4, Common LUT)

(Method 1) Suppose the channel capacity c₁^{(k)} of the signal s₁^{(k)} is (channel capacity c₁^{(k)} of signal s₁^{(k)})=(channel capacity c₂^{(k)} of signal s₂^{(k)}+disparity value with reference to the table in FIG. 16). With reference to a LUT common to the signal s₁ and signal s₂ as shown in FIG. 10, transmission rates corresponding to the respective values of the channel capacities c₁^{(k)} and c₂^{(k)} are assigned to the signals s₁^{(k)} and s₂^{(k)}

### (Assignment of Transmission Rate on a Per Subcarrier Basis, Premised on Coding Configuration in FIG. 5, Common LUT)

(Method 2) Suppose the channel capacity c₁^{(k)} of the signal s₁^{(k)} is (channel capacity c₁^{(k)} of signal s₁^{(k)})=(channel capacity c₂^{(k)} of signal s₂^{(k)}+disparity value with reference to the table in FIG. 16). With reference to the LUT common to the signal s₁ and signal s₂ as shown in FIG. 11, corresponding transmission rates are assigned to the signals s₁^{(k)} and s₂^{(k)} from the correlation between the values of the channel capacities c₁^{(k)} and c₂^{(k)}.

### (Assignment of Transmission Rate on a Per Subcarrier Basis, Premised on Coding Configuration in FIG. 5, Common LUT)

(Method 3) Suppose the channel capacity c₁^{(k)} of the signal s₁^{(k)} is (channel capacity c₁^{(k)} of signal s₁^{(k)})=(channel capacity c₂^{(k)} of signal s₂^{(k)}+disparity value with reference to the table in FIG. 16). With reference to the LUT common to the signal s₁ and signal s₂ as shown in FIG. 12, corresponding transmission rates are assigned to the signals s₁^{(k)} and s₂^{(k)} from the sum total of the values of the channel capacities c₁^{(k)} and c₂^{(k)}.

This embodiment has explained so far the case where the number of transmission streams to be multiplexed is two, but when the number of transmission streams is three, transmission rate control may also be performed on the basis of a signal for which the variation characteristic of a value which becomes a metric of transmission rate control with respect to a delay time becomes substantially constant. For example, the channel capacity c₁^{(k)} of the signal s₁^{(k)} is determined using a table showing spatial correlations and disparities in convergence values of channel capacities between the second stream and first stream on the basis of the channel capacity of the transmission signal S₂^{(k)} and likewise the channel capacity c₃^{(k)} of the signal s₃^{(k)} is determined using a table showing spatial correlations and disparities in convergence values of channel capacities between the second stream and third stream. Transmission rates may be assigned to the signals s₁^{(k)}, S₂^{(k)} and s₃^{(k)} with reference to the LUT showing a relationship between channel capacities and transmission rates based on the determined channel capacities.

### Effects of Third Embodiment

As explained so far, this embodiment performs transmission rate control on the basis of a signal for which the variation characteristic of a metric of transmission rate control with respect to a delay time becomes substantially constant and taking into consideration the spatial correlation, and can thereby reduce overhead for the radio communication apparatus to acquire a channel response, avoid transmission rate assignment errors for an elapsed time after acquiring the channel response and improve the throughput of the entire system.

### Fourth Embodiment

A radio communication apparatus according to this embodiment has the same configuration as that in FIG. 3 and is also similar to the second embodiment in that a weight vector is determined based on a channel response and signals are multiplexed using different directional beams for different subcarriers and transmitted and transmission rate control is performed on the basis of a signal for which the variation characteristic of a metric of transmission rate control with respect to a delay time becomes substantially constant. This embodiment differs from the second embodiment in that transmission rates are assigned taking a spatial correlation into consideration when performing transmission rate control.

### (Transmission Rate Control Method of Fourth Embodiment)

Hereinafter, a more specific transmission rate control method of this embodiment will be explained.

### (Determination of C2)

[1] First of all, the transmission rate control unit 301 will determine the channel capacity c₂^{(k)} of the signal s₂^{(k)} of each subcarrier and calculates a channel capacity \tilde{c}₂ averaged among all subcarriers.

To calculate the channel capacity c₂^{(k)} of the signal s₂^{(k)}, singular values obtained by the transmission weight generation unit 305 by applying singular value decomposition to the channel response reported from the reception terminal may be sent as a transmission rate control signal 313 to the transmission rate control unit 301 and the transmission rate control unit 301 may calculate the channel capacity c₂^{(k)} using Formula (10-2). Furthermore, a channel response or transmission weight may also be sent with the transmission rate control signal 313 to the transmission rate control unit 301 and the channel capacity may be calculated using a ZF norm as shown in Formula (11) or an MMSE norm as shown in Formula (12). Here, the channel capacity calculation method of this embodiment is not limited to the above described method. Any method may be used as far as it allows the radio communication apparatus to detect a channel capacity.

### (Determination of C1)

[2] Next, an average channel capacity \tilde{c}₁ of the signal s₁ will be determined on the basis of the average channel capacity \tilde{c}₂ of the signal s₂ calculated by the transmission rate control unit 301. When determining the channel capacity \tilde{c}₁, a table as shown in FIG. 16 is used which shows spatial correlations (here, mean value of all subcarriers) and disparities in channel capacities between the second stream and first stream. The disparities in channel capacities between the second stream and first stream also vary depending on the SNR, and therefore the table in FIG. 16 stores values expressing disparities in each SNR.

The spatial correlations may be calculated as H(k)*H(k)^{H} or H(k)^{H}*H(k) based on the channel response known to the radio communication apparatus or the transmission weight generation unit 305 may calculate a conditional number (maximum singular value/minimum singular value) using a maximum singular value and a minimum singular value obtained when carrying out singular value decomposition and use it as an index of spatial correlation. Here, the spatial correlation calculation method of this embodiment is not limited to the method explained above. Any method may be used as far as it allows the radio communication apparatus to calculate anything that can be handled as a spatial correlation.

In a communication mode in which transmission beam forming is performed, an SNR is generally reported together when a channel response is reported from the reception terminal to the radio communication apparatus. Therefore, the radio communication apparatus can make the SNR known. Furthermore, the radio communication apparatus may also estimate an SNR using a known signal added to a packet when the reception terminal reports a channel response to the radio communication apparatus. Since the SNR estimation method has no influence on the essence of the present invention, detailed explanations thereof will be omitted.

### (Determination of Transmission Rate)

[3] Next, the average channel capacities \tilde{c}₁ and \tilde{c}₂ calculated by the transmission rate control unit 301 are inputted as the metric signal 311 to the storage 302. The storage 302 stores a LUT showing a relationship between channel capacities and transmission rates, selects a transmission rate from an inputted channel capacity with reference to the LUT and reports the selected transmission rate as the selected transmission rate signal 312 to the transmission rate control unit 301.

The above described LUT showing the relationship between channel capacities and transmission rates may be created based on a characteristic acquired beforehand (e.g., channel capacity versus bit error rate characteristic, channel capacity versus packet error rate characteristic).

### (Detailed Explanation of [2] and [3])

Here, the method of selecting a transmission rate from the average channel capacity inputted to the storage 302 explained in [3] with reference to the LUT will be explained in detail together with the method of determining the average channel capacity \tilde{c}₁ of the signal s₁ from the average channel capacity \tilde{c}₂ of the signal s₂ explained in [2].

### (Assignment of the Same Transmission Rate to all Subcarriers, Premised on Coding Configuration in FIG. 4, Common LUT)

(Method 4) Suppose the average channel capacity \tilde{c}₁ of the signal s₁ is (average channel capacity \tilde{c}₁ of signal s₁)=(average channel capacity \tilde{c}₂ of signal s₂+disparity value with reference to the table in FIG. 16). With reference to the LUT common to the signal s₁ and signal s₂ as shown in FIG. 10, transmission rates corresponding to the respective values of the channel capacities \tilde{c}₁ and \tilde{c}₂ are assigned to the signals s₁ and s₂.

### (Assignment of the Same Transmission Rate to all Subcarriers, Premised on Coding Configuration in FIG. 4, Individual LUTs)

(Method 5) Suppose the average channel capacity \tilde{c}₁ of the signal s₁ is (average channel capacity \tilde{c}₁ of signal s₁=(average channel capacity \tilde{c}₂ of signal s₂+disparity value with reference to the table in FIG. 16). Taking into consideration the fact that the distribution of channel capacities of all subcarriers of a lower signal is greater than the distribution of channel capacities of all subcarriers of a higher signal, transmission rates corresponding to the respective values of channel capacities \tilde{c}₁ and \tilde{c}₂ are assigned to signals s₁ and s₂ with reference to the individual LUTs of the signal s₁ and signal s₂ as shown in FIG. 13.

### (Assignment of the Same Transmission Rate to all Subcarriers, Premised on Coding Configuration in FIG. 4, Common LUT)

(Method 6) Taking into consideration the fact that the distribution of channel capacities of all subcarriers of a lower signal is greater than the distribution of channel capacities of all subcarriers of a higher signal, the average channel capacity \tilde{c}₁ of the signal s₁ is assumed to be (average channel capacity \tilde{c}₁ of signal s₁)=(average channel capacity \tilde{c}₂ of signal s₂+disparity value with reference to the table in FIG. 16+α), an amount of advantage α is given to the signal s₁, and transmission rates corresponding to the values of channel capacities \tilde{c}₁ and \tilde{c}₂ are assigned to the signals s₁ and s₂ with reference to the LUT common to the signal s₁ and signal s₂ as shown in FIG. 10.

### (Assignment of the Same Transmission Rate to all Subcarriers, Premised on Coding Configuration in FIG. 5, Common LUT)

(Method 7) Suppose the average channel capacity \tilde{c}₁ of the signal s₁ is (average channel capacity \tilde{c}₁ of signal s₁)=(average channel capacity \tilde{c}₂ of signal s₂+disparity value with reference to the table in FIG. 16). With reference to the LUT common to the signal s₁ and signal s₂ as shown in FIG. 11, corresponding transmission rates are assigned to the signals s₁ and s₂ from the correlation between the values of channel capacities \tilde{c}₁ and \tilde{c}₂.

### (Assignment of the Same Transmission Rate to all Subcarriers, Premised on Coding Configuration in FIG. 5, Common LUT)

(Method 8) Suppose an average channel capacity \tilde{c}₁ of the signal s₁ is (average channel capacity \tilde{c}₁ of signal s₁)=(average channel capacity \tilde{c}₂ of signal s₂+disparity value with reference to the table in FIG. 16). With reference to the LUT common to the signal s₁ and signal s₂ as shown in FIG. 12, corresponding transmission rates are assigned to the signals s₁ and s₂ from the sum total of the values of the channel capacities \tilde{c}₁ and \tilde{c}₂.

### (Assignment of the Same Transmission Rate to all Subcarriers, Premised on Coding Configuration in FIG. 5, Common LUT)

(Method 9) Taking into consideration the fact that the distribution of channel capacities of all subcarriers of a lower signal is greater than the distribution of channel capacities of all subcarriers of a higher signal, the average channel capacity \tilde{c}₁ of the signal s₁ is assumed to be (average channel capacity \tilde{c}₁ of signal s₁)=(average channel capacity \tilde{c}₂ of signal s₂+disparity value with reference to the table in FIG. 16+α), an amount of advantage cc is given to the signal s₁, and with reference to the LUT common to the signal s₁ and signal s₂ as shown in FIG. 11, corresponding transmission rates are assigned to the signals s₁ and s₂ from the correlation between the values of the channel capacities \tilde{c}₁ and \tilde{c}₂.

### (Assignment of the Same Transmission Rate to all Subcarriers, Premised on Coding Configuration in FIG. 5, Common LUT)

(Method 10) Taking into consideration the fact that the distribution of channel capacities of all subcarriers of a lower signal is greater than the distribution of channel capacities of all subcarriers of a higher signal, the average channel capacity \tilde{c}₁ of the signal s₁ is assumed to be (average channel capacity \tilde{c}₁ of signal s₁)=(average channel capacity \tilde{c}₂ of signal s₂+disparity value with reference to the table in FIG. 16+α), an amount of advantage α is given to the signal s₁, and with reference to the LUT common to the signal s₁ and signal s₂ as shown in FIG. 11, corresponding transmission rates are assigned to the signals s₁ and s₂ from the sum total of the channel capacities \tilde{c}₁ and \tilde{c}₂.

Here, the method of selecting transmission rates from the LUT showing a relationship between channel capacities and transmission rates of this embodiment is not limited to the methods explained above. Any method may be used as far as it allows the radio communication apparatus to select a transmission rate based on the channel capacity.

### Effects of Fourth Embodiment

As explained so far, this embodiment performs transmission rate control on the basis of a signal for which the variation characteristic of a metric of transmission rate control with respect to a delay time becomes substantially constant, and can thereby reduce overhead for the radio communication apparatus to acquire a channel response, avoid transmission rate assignment errors for an elapsed time after acquiring a channel response and improve the throughput of the entire system.

### Fifth Embodiment

A radio communication apparatus according to this embodiment has the same configuration as that in FIG. 3, is similar to the first embodiment in that a weight vector is determined based on a channel response and signals are multiplexed using different directional beams for different subcarriers and transmitted and transmission rates are selected taking a delay time into consideration. This embodiment differs from the first embodiment in that when performing transmission rate control, transmission rate control is performed with reference to convergence values (worst values) of channel capacities in a table based on a spatial correlations and SNR when the delay time reaches a sufficiently large level.

Examples of factors which determine the delay time versus channel capacity variation characteristic include the number of transmission radio units, Doppler frequency, transmission weight generation method, spatial correlation and SNR. Of these factors, the number of transmission radio units, Doppler frequency and transmission weight generation method can be fixed when an applicable system is determined (e.g., the number of transmission radio units: 3, indoor space Doppler frequency: approximately 10 Hz, transmission weight generation method: singular value decomposition base). Therefore, if a spatial correlation and SNR are known, it is possible to estimate a channel capacity (channel capacity need not directly be calculated) and also grasp the delay time versus channel capacity variation characteristic.

Therefore, when performing transmission rate control, this embodiment selects a transmission rate based on a spatial correlation value and SNR with reference to worst values (convergence values) of channel capacities of the respective signals in the table when the delay time reaches a sufficiently large level.

Hereinafter, a more specific transmission rate control method of this embodiment will be explained. In the case of an OFDM-based system, the transmission rate assignment method can be roughly divided into a case where different transmission rates are assigned to different subcarriers and a case where a common transmission rate is assigned to all subcarriers, and therefore the former will be explained in this embodiment and the latter will be explained in a sixth embodiment separately.

### (Transmission Rate Control Method According to Fifth Embodiment)

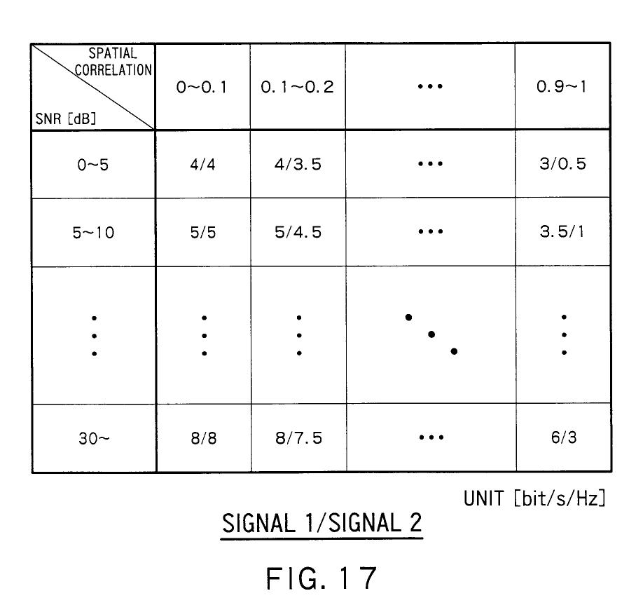

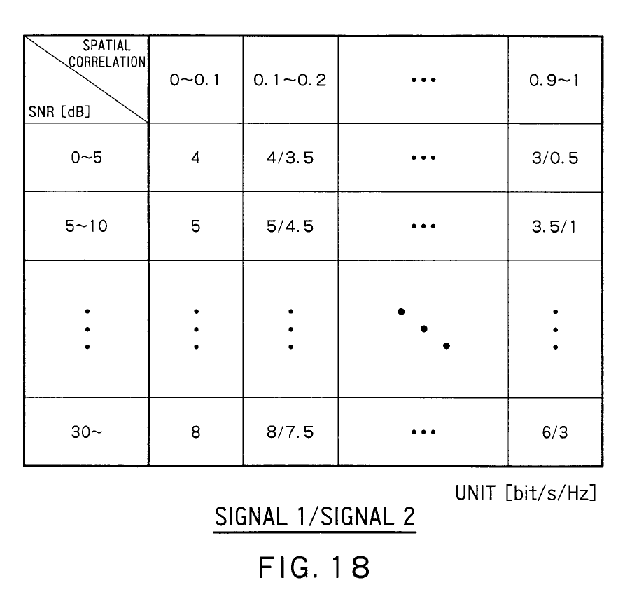

### (Determination of C1 and C2)

[1] First of all, the transmission rate control unit 301 inputs a spatial correlation value and an SNR to the storage 302 and the storage 302 determines the channel capacity of each signal with reference to the table showing the convergence value (worst value) of the channel capacity of each signal when the delay time as shown in FIG. 17 reaches a sufficiently large level. When the spatial correlation is small, since the channel capacity of the signal 1 when the delay time reaches a sufficiently large level is substantially the same as the channel capacity of the signal 2 in the table in FIG. 17, the table may also be like one as shown in FIG. 18.

### (Determination of Transmission Rate)

[2] Next, a transmission rate is selected with reference to a LUT showing a relationship between channel capacities and transmission rates stored in the storage 302 from the determined channel capacities c₁^{(k)} and c₂^{(k)} and the selected transmission rate is reported as the selected transmission rate signal 312 to the transmission rate control unit 301.

The above described LUT showing the relationship between channel capacities and transmission rates may be created based on a characteristic acquired beforehand (e.g., channel capacity versus bit error rate characteristic, channel capacity versus packet error rate characteristic).

### (Detailed Explanation of [2])

Here, the method of selecting a transmission rate based on the channel capacity inputted to the storage 302 explained in [2] will be explained in detail with reference to the LUT.

### (Assignment of Transmission Rate on a Per Subcarrier Basis, Premised on Coding Configuration in FIG. 4, Common LUT)

(Method 1) Transmission rates corresponding to the values of the respective channel capacities c₁^{(k)} and c₂^{(k)} are assigned to the signals s₁^{(k)} and s₂^{(k)} with reference to the LUT common to the signal s₁ and signal s₂ as shown in FIG. 10.

### (Assignment of Transmission Rate on a Per Subcarrier Basis, Premised on Coding Configuration in FIG. 5, Common LUT)

(Method 2) With reference to the LUT common to the signal s₁ and signal s₂ as shown in FIG. 11, corresponding transmission rates are assigned to the signals s₁^{(k)} and s₂^{(k)} from the correlation between the values of the channel capacities c₁^{(k)} and c₂^{(k)}.

### Effects of Fifth Embodiment

As explained so far, this embodiment performs transmission rate control based on a metric of transmission rate control with which the variation characteristic with respect to a delay time becomes substantially constant, and can thereby reduce overhead for the radio communication apparatus to acquire a channel response, avoid transmission rate assignment errors for an elapsed time after acquiring the channel response and improve the throughput of the entire system.

### Sixth Embodiment

A radio communication apparatus according to this embodiment has the same configuration as that in FIG. 3 and is also similar to the second embodiment in that a weight vector is determined based on a channel response and signals are multiplexed using different directional beams for different subcarriers and transmitted and transmission rates are selected taking a delay time into consideration. This embodiment differs from the second embodiment in that when performing transmission rate control, transmission rate control is performed with reference to convergence values (worst values) of channel capacities in a table based on a spatial correlation and SNR when the delay time reaches a sufficiently large level.

Examples of factors which determine the delay time versus channel capacity variation characteristic include the number of transmission radio units, Doppler frequency, transmission weight generation method, spatial correlation and SNR. Of these factors, the number of transmission radio units, Doppler frequency and transmission weight generation method can be fixed when an applicable system is determined (e.g., the number of transmission radio units: 3, indoor space Doppler frequency: approximately 10 Hz, transmission weight generation method: singular value decomposition base). Therefore, if a spatial correlation and SNR are known, it is possible to estimate a channel capacity (channel capacity need not directly be calculated) and also grasp the delay time versus channel capacity variation characteristic.

Therefore, when performing transmission rate control, this embodiment selects a transmission rate with reference to worst values (convergence values) of channel capacities of the respective signals in the table based on a spatial correlation value and SNR when the delay time reaches a sufficiently large level.

### (Transmission Rate Control Method of Sixth Embodiment)

Hereinafter, a more specific transmission rate control method of this embodiment will be explained.

### (Determination of C1 and C2)

[1] First of all, the transmission rate control unit 301 inputs a spatial correlation value and an SNR to the storage 302 and the storage 302 determines the channel capacities c₁^{(k)} and c₂^{(k)} of the signals s₁^{(k)} and s₂^{(k)} of the respective subcarriers with reference to the table showing the convergence value (worst value) of the channel capacity of each signal when the delay time as shown in FIG. 17 reaches a sufficiently large level and calculates channel capacities \tilde{c}₁ and \tilde{c}₂ averaged among all subcarriers. When the spatial correlation is small, since the channel capacity of the signal 1 when the delay time reaches a sufficiently large level is substantially the same as the channel capacity of the signal 2 in the table in FIG. 17, the table may also be like one as shown in FIG. 18.

### (Determination of Transmission Rate)

[2] Next, a transmission rate is selected with reference to a LUT showing a relationship between channel capacities and transmission rates stored in the storage 302 from the determined channel capacities \tilde{c}₁ and \tilde{c}₂ and the selected transmission rate is reported as a selected transmission rate signal 312 to the transmission rate control unit 301.

The above described LUT showing the relationship between channel capacities and transmission rates may be created based on a characteristic acquired beforehand (e.g., channel capacity versus bit error rate characteristic, channel capacity versus packet error rate characteristic).

### (Detailed Explanation of [2])

Here, the method of selecting a transmission rate based on the channel capacity inputted to the storage 302 with reference to the LUT explained in [2] will be explained in detail.

### (Assignment of the Same Transmission Rate to all Subcarriers, Premised on Coding Configuration in FIG. 4, Common LUT)

(Method 3) Transmission rates corresponding to the values of the channel capacities \tilde{c}₁ and \tilde{c}₂ are assigned to the signals s₁ and s₂ with reference to the LUT common to the signal s₁ and signal s₂ as shown in FIG. 10.

### (Assignment of the Same Transmission Rate to all Subcarriers, Premised on Coding Configuration in FIG. 4, Individual LUTs)

(Method 4) With reference to the individual LUTs of the signal s₁ and signal s₂ as shown in FIG. 13, transmission rates corresponding to the respective values of the channel capacities \tilde{c}₁ and \tilde{c}₂ are assigned to the signals s₁ and s₂.

### (Assignment of the Same Transmission Rate to all Subcarriers, Premised on Coding Configuration in FIG. 5, Individual LUTs)

(Method 5) With reference to the LUT common to the signal s₁ and signal s₂ as shown in FIG. 11, corresponding transmission rates are assigned to the signals s₁ and s₂ from the correlation between the values of the channel capacities \tilde{c}₁ and \tilde{c}₂.

### (Assignment of the Same Transmission Rate to all Subcarriers, Premised on Coding Configuration in FIG. 5, Common LUT)

(Method 6) With reference to the LUT common to the signal s₁ and signal s₂ as shown in FIG. 12, corresponding transmission rates are assigned to the signals s₁ and s₂ from the sum total of the values of the channel capacities \tilde{c}₁ and \tilde{c}₂.

Here, the method of selecting a transmission rate from the LUT showing a relationship between channel capacities and transmission rates of this embodiment is not limited to the above described method. Any method may be used as far as it allows the radio communication apparatus to select the transmission rate based on the channel capacity.

### Effects of Sixth Embodiment

As explained so far, this embodiment performs transmission rate control based on a metric of transmission rate control with which the variation characteristic with respect to a delay time becomes substantially constant, and can thereby reduce overhead for the radio communication apparatus to acquire a channel response, avoid transmission rate assignment errors for an elapsed time after acquiring the channel response and improve the throughput of the entire system.

### Seventh Embodiment

A radio communication apparatus according to this embodiment has the same configuration as that in FIG. 3 and is also similar to the first embodiment in that a weight vector is determined based on a channel response and signals are multiplexed using different directional beams for different subcarriers and transmitted and transmission rates are selected taking a delay time into consideration. This embodiment differs from the first embodiment in that transmission rate control is performed with reference to a table showing the variation characteristic of a metric of transmission rate control with respect to a delay time.

Examples of factors which determine the delay time versus channel capacity variation characteristic include the number of transmission radio units, Doppler frequency, transmission weight generation method, spatial correlation and SNR. Of these factors, the number of transmission radio units, Doppler frequency and transmission weight generation method can be fixed when an applicable system is determined (e.g., the number of transmission radio units: 3, indoor space Doppler frequency: approximately 10 Hz, transmission weight generation method: singular value decomposition base). Therefore, if a spatial correlation and SNR are known, it is possible to estimate a channel capacity (channel capacity need not directly be calculated) and also grasp the delay time versus channel capacity variation characteristic.

Furthermore, the radio communication apparatus using a transmission beam forming scheme is generally provided with a timer for grasping an elapsed time after transmitting a known signal for channel estimation and the radio communication apparatus can thereby calculate a delay time. The transmission rate control unit 301 in the radio communication apparatus may also be provided with a delay time calculation unit which calculates a delay time.

Therefore, in this embodiment, the storage 302 is provided with a table showing a delay time versus channel capacity characteristic and selects a transmission rate from a channel capacity corresponding to the delay time.

Hereinafter, a more specific transmission rate control method of this embodiment will be explained. In the case of an OFDM-based system, the transmission rate assignment method can be roughly divided into a case where different transmission rates are assigned to different subcarriers and a case where a common transmission rate is assigned to all subcarriers, and therefore the former will be explained in this embodiment and the latter will be explained in an eighth embodiment separately.

### (Transmission Rate Control Method of Seventh Embodiment)

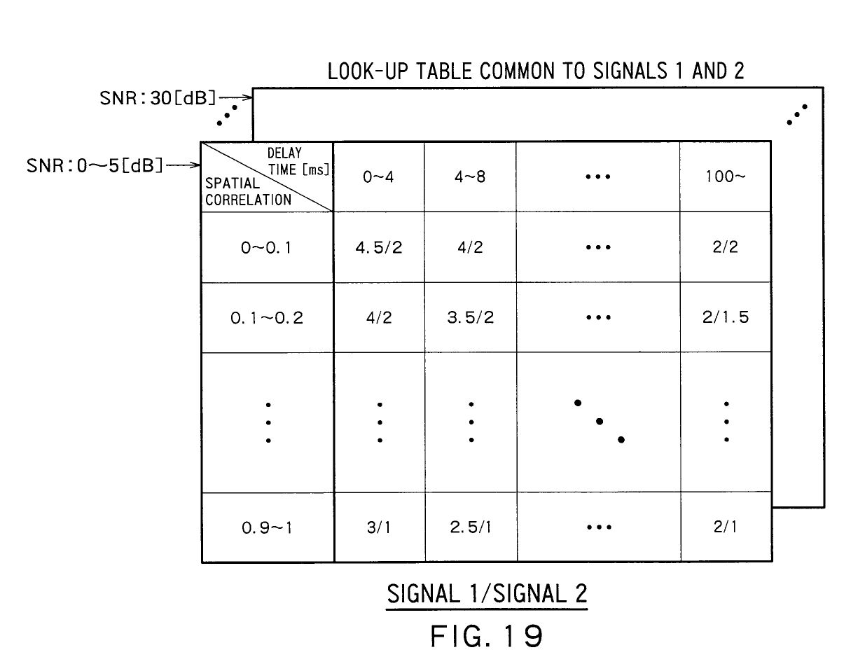

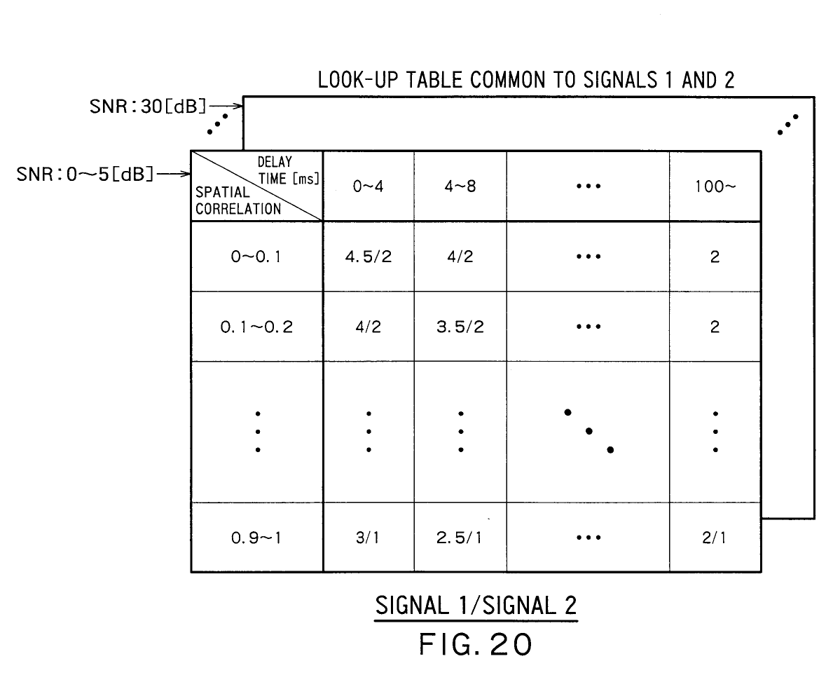

### (Determination of C1 and C2)

[1] First of all, the transmission rate control unit 301 inputs a spatial correlation value and SNR to the storage 302 and the storage 302 determines channel capacities c₁^{(k)} and c₂^{(k)} of the respective signals according to the delay time from a table showing a relationship between a delay time and channel capacity for each spatial correlation and each SNR as shown in FIG. 19. When the spatial correlation is small, the channel capacity of the signal 1 substantially matches the channel capacity of the signal 2 when the delay time increases, and therefore the table in FIG. 19 may also be like one as shown in FIG. 20.

### (Determination of Transmission Rate)

[2] Next, a transmission rate is selected from the determined channel capacities c₁^{(k)} and c₂^{(k)} with reference to a LUT showing a relationship between channel capacities and transmission rates stored in the storage 302 and the selected transmission rate is reported to the transmission rate control unit 301 as the selected transmission rate signal 312.

The above described LUT showing the relationship between channel capacities and transmission rates may be created based on a characteristic acquired beforehand (e.g., channel capacity versus bit error rate characteristic, channel capacity versus packet error rate characteristic).

### (Detailed Explanation of [2])

Here, the method of selecting a transmission rate based on the channel capacity inputted to the storage 302 explained in [2] with reference to the LUT will be explained in detail.

### (Assignment of Transmission Rate on a Per Subcarrier Basis, Premised on Coding Configuration in FIG. 4, Common LUT)

(Method 1) With reference to the LUT common to the signal s₁ and signal s₂ as shown in FIG. 10, transmission rates corresponding to the respective values of the channel capacities c₁^{(k)} and c₂^{(k)} are assigned to the signals s₁^{(k)} and s₂^{(k)}

### (Assignment of Transmission Rate on a Per Subcarrier Basis, Premised on Coding Configuration in FIG. 5, Common LUT)

(Method 2) With reference to the LUT common to the signal s₁ and signal s₂ as shown in FIG. 11, corresponding transmission rates are assigned to the signals s₁^{(k)} and s₂^{(k)} from the correlation between the values of the channel capacities c₁^{(k)} and c₂(k).

### (Assignment of the Same Transmission Rate to all Subcarriers, Premised on Coding Configuration in FIG. 5, Common LUT)

(Method 3) With reference to the LUT common to the signal s₁ and signal s₂ as shown in FIG. 12, the corresponding transmission rates are assigned to the signals s₁^{(k)} and s₂^{(k)} from the sum total of the values of the channel capacities c₁^{(k)} and c₂^{(k)}.

### Effects of Seventh Embodiment

As explained so far, this embodiment performs transmission rate control taking into consideration the characteristic of a metric with respect to a delay time, and can thereby reduce overhead for the radio communication apparatus to acquire a channel response, and at the same time avoid transmission rate assignment errors for a lapse of time after acquiring the channel response and improve the throughput of the entire system.

### Eighth Embodiment

A radio communication apparatus according to this embodiment has the same configuration as that in FIG. 3, and is similar to the second embodiment in that a weight vector is determined based on a channel response and transmission is performed by multiplexing signals using directional beams which vary from one subcarrier to another and a transmission rate is selected taking a delay time into consideration. This embodiment differs from the second embodiment in that transmission rate control is performed with reference to a table showing the variation characteristic of a metric of transmission rate control with respect to the delay time.

Examples of factors which determine the delay time versus channel capacity variation characteristic include the number of transmission radio units, Doppler frequency, transmission weight generation method, spatial correlation and SNR. Of these factors, the number of transmission radio units, Doppler frequency and transmission weight generation method can be fixed when an applicable system is determined (e.g., the number of transmission radio units: 3, indoor space Doppler frequency: approximately 10 Hz, transmission weight generation method: singular value decomposition base). Therefore, if a spatial correlation and SNR are known, it is possible to estimate a channel capacity (channel capacity need not directly be calculated) and also grasp the delay time versus channel capacity variation characteristic.

Furthermore, the radio communication apparatus using a transmission beam forming scheme is generally provided with a timer for grasping an elapsed time after transmitting a known signal for channel estimation and the radio communication apparatus can thereby calculate a delay time.

Therefore, in this embodiment, the storage 302 is provided with a table showing a delay time versus channel capacity characteristic and selects a transmission rate from a channel capacity corresponding to the delay time.

### (Transmission Rate Control Method of Eighth Embodiment)

Hereinafter, a more specific transmission rate control method of this embodiment will be explained.

### (Determination of C1 and C2)

[1] First of all, the transmission rate control unit 301 inputs a spatial correlation value and SNR to the storage 302 and the storage 302 determines channel capacities c₁^{(k)} and c₂^{(k)} of the respective signals according to the delay time from a table showing a relationship between a delay time and channel capacity for each spatial correlation and each SNR as shown in FIG. 19 and calculates channel capacities \tilde{c}₁ and \tilde{c}₂ averaged among all subcarriers. When the spatial correlation is small, the channel capacity of the signal 1 substantially matches the channel capacity of the signal 2 when the delay time increases, and therefore the table in FIG. 19 may also be like one as shown in FIG. 20.

### (Determination of Transmission Rate)

[2] Next, a transmission rate is selected from the determined channel capacities \tilde{c}₁ and \tilde{c}₂ with reference to a LUT showing a relationship between channel capacities and transmission rates stored in the storage 302 and the selected transmission rate is reported to the transmission rate control unit 301 as a selected transmission rate signal 312.

The above described LUT showing the relationship between channel capacities and transmission rates may be created based on a characteristic acquired beforehand (e.g., channel capacity versus bit error rate characteristic, channel capacity versus packet error rate characteristic).

### (Detailed Explanation of [2])

Here, the method of selecting a transmission rate based on the channel capacity inputted to the storage 302 explained in [2] with reference to the LUT will be explained in detail.

### (Assignment of the Same Transmission Rate to all Subcarriers, Premised on Coding Configuration in FIG. 4, Common LUT)

(Method 4) With reference to the LUT common to the signal s₁ and signal s₂ as shown in FIG. 10, transmission rates corresponding to the respective values of the channel capacities \tilde{c}₁ and \tilde{c}₂ are assigned to the signals s₁ and s₂.

### (Assignment of the Same Transmission Rate to all Subcarriers, Premised on Coding Configuration in FIG. 4, Individual LUTs)

(Method 5) With reference to the individual LUTs of the signal s₁ and signal s₂ as shown in FIG. 13, transmission rates corresponding to the values of channel capacities \tilde{c}₁ and \tilde{c}₂ are assigned to the signals s₁ and s₂.

### (Assignment of the Same Transmission Rate to all Subcarriers, Premised on Coding Configuration in FIG. 5, Common LUT)

(Method 6) With reference to the LUT common to the signal s₁ and signal s₂ as shown in FIG. 11, transmission rates corresponding to the values of the channel capacities \tilde{c}₁ and \tilde{c}₂ are assigned to the signals s₁ and s₂.

### (Assignment of the Same Transmission Rate to all Subcarriers, Premised on Coding Configuration in FIG. 5, Common LUT)

(Method 7) With reference to the LUT common to the signal s₁ and signal s₂ as shown in FIG. 12, corresponding transmission rates are assigned to the signals s₁ and s₂ from the sum total of the values of the channel capacities \tilde{c}₁ and \tilde{c}₂.

Here, the method of selecting transmission rates from the LUT showing a relationship between channel capacities and transmission rates of this embodiment is not limited to the methods explained above. Any method may be used as far as it allows the radio communication apparatus to select a transmission rate based on the channel capacity.

### Effects of Eighth Embodiment

As explained so far, this embodiment performs transmission rate control taking into consideration the characteristic of a metric with respect to a delay time, and can thereby reduce overhead for the radio communication apparatus to acquire a channel response, avoid transmission rate assignment errors for an elapsed time after acquiring a channel response and improve the throughput of the entire system.

What is claimed is:

1. A radio communication apparatus for communicating with a receiver by using a plurality of antennas, comprising:
a channel response acquisition unit configured to acquire channel responses between the receiver and the antennas;
a transmission weight generation unit configured to generate first to nth (n is an integer equal to or greater than 2) transmission weights by which first to nth signals to be transmitted to the receiver are multiplied based on the channel responses;
a transmission rate control unit
configured to specify a signal having small variation of a metric, which is an index for evaluating a channel of the signal, out of the first to nth signals and control a transmission rate of a specified signal based on the channel responses and the transmission weight of the specified signal and
configured to control a transmission rate of each of other signals different from the specified signal out of the first to nth signals based on a relationship between a variation characteristic of a metric of the specified signal and a variation characteristic of a metric of each of the other signals;
a transmission weight multiplication unit configured to multiply the first to nth signals subjected to transmission rate control by the first to nth transmission weights to generate first to nth weight-multiplied signals; and
a transmission unit configured to transmit the first to nth weight-multiplied signals using the antennas respectively.

2. The apparatus according to claim 1, wherein
the transmission weight multiplication unit maps the first to nth signals to a plurality of subcarriers respectively;
the channel response acquisition unit acquires the channel responses between the receiver and the antennas on a per subcarrier basis;
the transmission weight generation unit generates the first to nth transmission weights for the first to nth signals on a per subcarrier basis;
the transmission weight multiplication unit multiplies the first to nth signals by the first to nth transmission weights on a per subcarrier basis, and
the transmission rate control unit controls transmission rates of the first to nth signals on a per subcarrier basis.

3. The apparatus according to claim 2,
wherein the transmission rate control unit
calculates a metric on a per subcarrier with respect to the specified signal based on the channel responses and the transmission weight of the specified signal,
adopts same value as that of the metric on a per subcarrier basis for the specified signal, as a metric on a per subcarrier basis with respect to each of the other signals, and
determines a transmission rate on a per subcarrier basis according to the metric on a per subcarrier basis with respect to each of the specified signal and the other signals.

4. The apparatus according to claim 2,
wherein the transmission rate control unit
calculates a metric on a per subcarrier with respect to the specified signal based on the channel responses and the transmission weight of the specified signal,
adopts same value as that of the metric on a per subcarrier basis for the specified signal, as a metric on a per subcarrier basis with respect to each of the other signals, and
calculates a sum total of metrics of corresponding subcarriers among the first to nth signals for each of the plurality of subcarriers and
determines a transmission rate on a per subcarrier basis with respect to each of the specified signal and the other signals according to the sum total for each of the subcarriers.

5. The apparatus according to claim 2,
wherein the transmission rate control unit
calculates a representative value of the metrics for the subcarriers with respect to the specified signal based on the channel responses and the transmission weight of the specified signal,
adopts same value as the representative value for the specified signal, as a representative value of the metrics for the subcarriers with respect to each of the other signals,
determines a transmission rate common to all subcarriers according to the representative value of each of the specified signal of the other signals with respect to each of the specified signal of the other signals.

6. The apparatus according to claim 2,
wherein the transmission rate control unit
calculates a representative value of the metrics for the subcarriers with respect to the specified signal based on the channel responses and the transmission weight of the specified signal,
adopts a value resulting from adding an advantage amount to the representative value for the specified signal as a representative value of the metrics for the subcarriers with respect to each of the other signals,
determines a transmission rate common to all subcarriers according to the representative value of each of the specified signal of the other signals with respect to each of the specified signal and the other signals.

7. The apparatus according to claim 2,
wherein the transmission rate control unit
calculates a representative value of the metrics for the subcarriers with respect to the specified signal based on the channel responses and the transmission weight of the specified signal,
adopts a value resulting from adding an advantage amount to the representative value for the specified signal as a representative value of the metrics for the subcarriers with respect to each of the other signals,
calculates correlations in representative values between the specified signal and the other signals, and
determines a transmission rate common to all subcarriers according to calculated correlations with respect to each of the specified signal and the other signals, respectively.

8. The apparatus according to claim 2,
wherein the transmission rate control unit
calculates a representative value of the metrics for the subcarriers with respect to the specified signal based on the channel responses and the transmission weight of the specified signal,
adopts same value as the representative value for the specified signal, as a representative value of the metrics for the subcarriers with respect to each of the other signals,
calculates a sum total of metrics of corresponding subcarriers among the first to nth signals for each of the plurality of subcarriers and
determines a transmission rate common to all subcarriers with respect to each of the specified signal and the other signals according to the sum total for each of the subcarriers.

9. The apparatus according to claim 2, further comprising a spatial correlation acquisition unit configured to acquire a spatial correlation value on a per subcarrier basis between the antennas and the receiver on a basis of the channel responses, wherein
calculates a metric on a per subcarrier with respect to the specified signal based on the channel responses and the transmission weight of the specified signal,
calculates a metric on a per subcarrier with respect to each of the other signals based on the metric on a per subcarrier calculated with respect to the specified signal and a calculated spatial correlation on a per subcarrier basis, and
determines a transmission rate on a per subcarrier basis according to the metric on a per subcarrier basis with respect to each of the specified signal and the other signals.

10. The apparatus according to claim 2, further comprising a spatial correlation acquisition unit configured to acquire a spatial correlation value on a per subcarrier basis between the antennas and the receiver on a basis of the channel responses, wherein
calculates a metric on a per subcarrier with respect to the specified signal based on the channel responses and the transmission weight of the specified signal,
calculates a metric on a per subcarrier with respect to each of the other signals based on the metric on a per subcarrier calculated with respect to the specified signal and a calculated spatial correlation on a per subcarrier basis, and
calculates correlations in metrics on a per subcarrier between the specified signal and the other signals, and
determines a transmission rate on a per subcarrier basis according to the correlations on a per subcarrier basis with respect to each of the specified signal and the other signals.

11. The apparatus according to claim 2, further comprising a spatial correlation acquisition unit configured to acquire a spatial correlation value on a per subcarrier basis between the antennas and the receiver on a basis of the channel responses, wherein
calculates a metric on a per subcarrier with respect to the specified signal based on the channel responses and the transmission weight of the specified signal,
calculates a metric on a per subcarrier with respect to each of the other signals based on the metric on a per subcarrier calculated with respect to the specified signal and a calculated spatial correlation acquisition on a per subcarrier basis, and
calculates a sum total of metrics of corresponding subcarriers among the first to nth signals for each of the plurality of subcarriers and
determines a transmission rate on a per subcarrier basis with respect to each of the specified signal and the other signals according to the sum total for each of the subcarriers.

12. The apparatus according to claim 9, further comprising an SNR acquisition unit configured to acquire an SNR on a per subcarrier basis or among all subcarriers,
wherein the transmission rate control unit calculates the metric on a per subcarrier basis with respect to each of the other signals by further using the SNR on a per subcarrier basis or among all subcarriers.

13. The apparatus according to claim 2, further comprising a spatial correlation acquisition unit configured to acquire a spatial correlation value on a per subcarrier basis between the antennas and the receiver on a basis of the channel responses,
wherein the transmission rate control unit
calculates a representative value of the metrics for the subcarriers with respect to the specified signal based on the channel responses and the transmission weight of the specified signal,
calculates a representative value of the metrics for the subcarriers with respect to each of the other signals based on the representative value calculated with respect to the specified signal and a calculated spatial correlation value on a per subcarrier basis, and
determines a transmission rate common to all subcarriers according to the representative value of each of the specified signal of the other signals with respect to each of the specified signal and the other signals.

14. The apparatus according to claim 13, wherein the transmission rate control unit
adds up the representative value calculated with respect to the specified signal, a predetermined value depending a representative value of the spatial correlation value on a per subcarrier basis and an advantage amount to obtain the representative value of the metrics for the subcarriers with respect to each of the other signals.

15. The apparatus according to claim 2, further comprising a spatial correlation acquisition unit configured to acquire a spatial correlation value on per subcarrier basis between the antennas and the receiver on a basis of the channel responses,
wherein the transmission rate control unit
calculates a representative value of the metrics for the subcarriers with respect to the specified signal based on the channel responses and the transmission weight of the specified signal,
calculates a representative value of the metrics for the subcarriers with respect to each of the other signals based on the representative value calculated with respect to the specified signal and a calculated spatial correlation value on a per subcarrier basis,
calculates correlations in representative values between the specified signal and the other signals, and
determines a transmission rate common to all subcarriers according to calculated correlations with respect to each of the specified signal and the other signals, respectively.

16. The apparatus according to claim 15, wherein the transmission rate control unit
adds up the representative value calculated with respect to the specified signal, a predetermined value depending a representative value of the spatial correlation value on a per subcarrier basis and an advantage amount to obtain the representative value of the metrics for the subcarriers with respect to each of the other signals.

17. The apparatus according to claim 2, further comprising a spatial correlation acquisition unit configured to acquire a spatial correlation value on per subcarrier basis between the antennas and the receiver on a basis of the channel responses,
wherein the transmission rate control unit
calculates a representative value of the metrics for the subcarriers with respect to the specified signal based on the channel responses and the transmission weight of the specified signal,
calculates a representative value of the metrics for the subcarriers with respect to each of the other signals based on the representative value calculated with respect to the specified signal and a calculated spatial correlation value on a per subcarrier basis,
calculates a sum total of each representative value among the first to nth signals and
determines a transmission rate common to all subcarriers with respect to each of the specified signal and the other signals according to the sum total.

18. The apparatus according to claim 17, wherein the transmission rate control unit
adds up the representative value calculated with respect to the specified signal, a predetermined value depending a representative value of the spatial correlation value on a per subcarrier basis and an advantage amount to obtain the representative value of the metrics for the subcarriers with respect to each of the other signals.

19. The apparatus according to claim 13, further comprising an SNR acquisition unit configured to acquire an SNR on a per subcarrier basis or among all subcarriers,
wherein the transmission rate control unit calculates the representative value of the metrics for the subcarriers with respect to each of the other signals by further using the SNR on a per subcarrier basis or among all subcarriers.

20. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a storage configured to store a table describing two metric convergence values for two signals in each pair of the specified signal and the other signal in association with a spatial correlation value and an SNR,
wherein the transmission rate control unit
acquires the metric convergence value on a per subcarrier basis for each of the specified signal and the other signals with reference to the table based on an acquired spatial correlation value on a per subcarrier basis and an acquired SNR on a per subcarrier basis or among all subcarriers, and
determines a transmission rate on a per subcarrier basis according to an acquired metric convergence value on a per subcarrier basis with respect to each of the specified signal and the other signals.

21. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a storage configured to store a table describing two metric convergence values for two signals in each pair of the specified signal and the other signal in association with a spatial correlation value and an SNR,
wherein the transmission rate control unit
acquires the metric convergence value on a per subcarrier basis for each of the specified signal and the other signals with reference to the table based on an acquired spatial correlation value on a per subcarrier basis and an acquired SNR on a per subcarrier basis or among all subcarriers,
calculates correlations in metric convergence values on a per subcarrier basis between the specified signal and the other signals, and
determines a transmission rate on a per subcarrier basis according to the correlations on a per subcarrier basis with respect to each of the specified signal and the other signals.

22. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a storage configured to store a table describing two metric convergence values for two signals in each pair of the specified signal and the other signal in association with a spatial correlation value and an SNR,
wherein the transmission rate control unit
acquires the metric convergence value on a per subcarrier basis for each of the specified signal and the other signals with reference to the table based on an acquired spatial correlation value on a per subcarrier basis and an acquired SNR on a per subcarrier basis or among all subcarriers,
calculates a representative value of the metric convergence values for the subcarriers with respect to each of the specified signal and the other signals, respectively and
determines a transmission rate common to all subcarriers according to a calculated representative value of the metric convergence values with respect to each of the specified signal and the other signals, respectively.

23. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a storage configured to store a table describing two metric convergence values for two signals in each pair of the specified signal and the other signal in association with a spatial correlation value and an SNR,
wherein the transmission rate control unit
acquires the metric convergence value on a per subcarrier basis for each of the specified signal and the other signals with reference to the table based on an acquired spatial correlation value on a per subcarrier basis and an acquired SNR on a per subcarrier basis or among all subcarriers,
calculates a representative value of the metric convergence values for the subcarriers with respect to each of the specified signal and the other signals, respectively
calculates correlations in representative values between the specified signal and the other signals, and
determines a transmission rate common to all subcarriers according to calculated correlations with respect to each of the specified signal and the other signals, respectively.

24. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a storage configured to store a table describing two metric convergence values for two signals in each pair of the specified signal and the other signal in association with a spatial correlation value and an SNR,
wherein the transmission rate control unit
acquires the metric convergence value on a per subcarrier basis for each of the specified signal and the other signals with reference to the table based on an acquired spatial correlation value on a per subcarrier basis and an acquired SNR on a per subcarrier basis or among all subcarriers,
calculates a representative value of the metric convergence values for the subcarriers with respect to each of the specified signal and the other signals, respectively
calculates a sum total of each representative value among the first to nth signals and
determines a transmission rate common to all subcarriers with respect to each of the specified signal and the other signals according to the sum total.

25. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a delay time calculation unit configured to calculate a delay time; and
a storage configured to store a table describing two metric convergence values for two signals in each pair of the specified signal and the other signal in association with a magnitude of the delay time, a spatial correlation value and an SNR,
wherein the transmission rate control unit
acquires the metric convergence value on a per subcarrier basis for each of the specified signal and the other signals with reference to the table based on a calculated delay time, an acquired spatial correlation value and an acquired SNR on a per subcarrier basis or among all subcarriers, and
determines a transmission rate on a per subcarrier basis according to an acquired metric convergence value on a per subcarrier basis with respect to each of the specified signal and the other signals.

26. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a delay time calculation unit configured to calculate a delay time; and
a storage configured to store a table describing two metric convergence values for two signals in each pair of the specified signal and the other signal in association with a magnitude of the delay time, a spatial correlation value and an SNR,
wherein the transmission rate control unit
acquires the metric convergence value on a per subcarrier basis for each of the specified signal and the other signals with reference to the table based on a calculated delay time, an acquired spatial correlation value and an acquired SNR on a per subcarrier basis or among all subcarriers,
calculates correlations in metric convergence values on a per subcarrier basis between the specified signal and the other signals, and
determines a transmission rate on a per subcarrier basis according to the correlations on a per subcarrier basis with respect to each of the specified signal and the other signals.

27. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a delay time calculation unit configured to calculate a delay time; and
a storage configured to store a table describing two metric convergence values for two signals in each pair of the specified signal and the other signal in association with a magnitude of the delay time, a spatial correlation value and an SNR,
wherein the transmission rate control unit
acquires the metric convergence value on a per subcarrier basis for each of the specified signal and the other signals with reference to the table based on a calculated delay time, an acquired spatial correlation value and an acquired SNR on a per subcarrier basis or among all subcarriers,
calculates a sum total of metric convergence values of corresponding subcarriers among the first to nth signals for each of the plurality of subcarriers, respectively and
determines a transmission rate on a per subcarrier basis with respect to each of the specified signal and the other signals according to the sum total for each of the subcarriers.

28. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a delay time calculation unit configured to calculate a delay time; and
a storage configured to store a table describing two metric convergence values for two signals in each pair of the specified signal and the other signal in association with a magnitude of the delay time, a spatial correlation value and an SNR,
wherein the transmission rate control unit
acquires the metric convergence value on a per subcarrier basis for each of the specified signal and the other signals with reference to the table based on a calculated delay time, an acquired spatial correlation value and an acquired SNR on a per subcarrier basis or among all subcarriers,
calculates a representative value of the metric convergence values for the subcarriers with respect to each of the specified signal and the other signals, respectively and
determines a transmission rate common to all subcarriers according to a calculated representative value of the metric convergence values with respect to each of the specified signal and the other signals, respectively.

29. The apparatus according to claim 2, further comprising:
a spatial correlation acquisition unit configured to acquire a spatial correlation value on a per subcarrier basis between the antennas and the receiver on a basis of the channel responses;
an SNR acquisition unit configured to acquire an SNR on a per subcarrier basis or among all subcarriers; and
a delay time calculation unit configured to calculate a delay time; and
a storage configured to store a table describing two metric convergence values for two signals in each pair of the specified signal and the other signal in association with a magnitude of the delay time, a spatial correlation value and an SNR,
wherein the transmission rate control unit
acquires the metric convergence value on a per subcarrier basis for each of the specified signal and the other signals with reference to the table based on a calculated delay time, an acquired spatial correlation value and an acquired SNR on a per subcarrier basis or among all subcarriers,
calculates correlations in metric convergence values on a per subcarrier basis between the specified signal and the other signals, and
determines a transmission rate on a per subcarrier basis according to the correlations on a per subcarrier basis with respect to each of the specified signal and the other signals.

30. A radio communication method of communicating between a transmitter having antennas and a receiver having antennas, comprising:
acquiring channel responses between the receiver and the transmitter;
generating first to nth (n is an integer equal to or greater than 2) transmission weights by which first to nth signals to be transmitted from the transmitter to the receiver are multiplied based on the channel responses;
specifying a signal having small variation of a metric, which is an index for evaluating a channel of the signal, out of the first to nth signals;
controlling a transmission rate of a specified signal based on the channel responses and the transmission weight of the specified signal;
controlling a transmission rate of each of other signals different from the specified signal out of the first to nth signals based on a relationship between a variation characteristic of a metric of the specified signal and a variation characteristic of a metric of each of the other signals;
multiplying the first to nth signals subjected to transmission rate control by the first to nth transmission weights to generate first to nth weight-multiplied signals; and
transmitting the first to nth weight-multiplied signals using the antennas respectively.
